(19) United States
(12) Patent Application Publication
(10) Pub. No.: US 2022/0414406 A1
(43) Pub. Date: Dec. 29, 2022

(54) Contactless Metal Transaction Cards, And A Compound Filled Recess For Embedding An Electronic Component

(71) Applicant: FEDERAL CARD SERVICES, LLC, Cincinnati, OH (US)

(72) Inventors: David Finn, Fussen Weissensee (DE); Daniel Pierrard, Newport, KY (US)

(21) Appl. No.: 17/803,322

(22) PCT Filed: Nov. 9, 2020
(86) PCT No.: PCT/US20/59597

§ 371 Date: May 9, 2022

Related U.S. Application Data
(60) Provisional application No. 62/932,506, filed on Nov. 8, 2019.
(60) Provisional application No. 62/936,453, filed on Nov. 16, 2019.
(60) Provisional application No. 62/964,138, filed on Jan. 22, 2020.
(60) Provisional application No. 63/004,491, filed on Apr. 2, 2020.

(51) Int. Cl. G06K 19/02; G06K 19/07; G06K 19/077

(52) U.S. Cl. CPC G06K 19/022; G06K 19/0723; G06K 19/07722

(57) ABSTRACT

A transaction card having a front “continuous” (with no slit) metal layer (530, 630, 730) with an opening (506, 612, 712) for a dual-interface transponder chip module (510, 610, 710). A shielding layer (540, 640, 742) comprising ferrite material (shielding layer) disposed below the metal layer. An amplifying element (507, 650, 744) disposed under the shielding layer. A metal interlayer (750, FIG. 7B) with a slit to function as a coupling frame (CF). A coupling frame antenna (507) having a single turn or track mounted on a supporting substrate (502). A rear plastic layer (560, 660, 760) formed of non-RF impeding material may capture a magnetic stripe and security elements (signature panel and hologram). The coupling frame antenna (507) may be integrated into the rear plastic layer. A portion of the front metal layer may protrude downward into the shielding layer. A dielectric spacer (548, 648, 748) may be disposed between the shielding layer and the amplifying element. A compound-filled recess for embedding an electronic component is also disclosed.

### CROSS-REFERENCES TO RELATED APPLICATIONS

Priority (filing date benefit) is claimed from the following, incorporated by reference herein:
nonprovisional of 63/004,491 filed 2 Apr. 2020
nonprovisional of 62/964,138 filed 22 Jan. 2020
nonprovisional of 62/936,453 filed 16 Nov. 2019
nonprovisional of 62/932,506 filed 8 Nov. 2019

### FIELD OF THE INVENTION

This invention relates to the field of metal transaction cards (smartcards) and, more particularly, passive RFID-enabled metal transaction cards having at least one metal layer and operating in contactless mode from one side of the card body.

This invention relates to the field of RFID-enabled metal transaction cards and, more particularly, metal transaction cards having a recess area(s) in the card body filled with a compound and post deposition thereof, mechanically forming the compound to accept the insertion of a component such as a transponder chip module or any electronic device.

Some of the disclosure(s) herein may relate to RFID-enabled metal transaction cards having a contactless interface only.

Some of the disclosure(s) herein may relate to metal transaction cards having a fingerprint sensor or a dynamic display.

Some of the disclosure(s) herein may relate to transaction cards made from a material other than metal.

### BACKGROUND OF THE INVENTION

A transaction card is a smartcard that comprises of an embedded electronic circuitry such as a secure microcontroller housed in a transponder chip module (TCM) with front contact pads and a rear micro-antenna that physical connects to or inductively couples with a reader or point of sale terminal. There are generally two categories of transaction cards referred to herein, as contactless only and dual interface (with contact and contactless functionality). In general, dual interface smartcards are passive devices, harvesting energy from the reader or terminal in contactless mode.

There is a growing market demand to have transaction cards with one or several layers of metal. A metal layer provides a desirable weight over conventional plastic cards, and a decorative pattern and/or a reflective metal surface enhances the card's appearance and aesthetic value. This is especially desirable for payment by affluent bank customers. It is therefore desirable to produce dual interface smartcards having a metal layer which operates in contact, but also in contactless mode.

However, a metal layer in a card body construction interferes with the electromagnetic field generated by a contactless reader or terminal thus attenuating the radio-frequency (RF) communication signal between the passive transaction card and the transceiver (reader or terminal).

The prior art suggests using a booster antenna for contactless communication, and a ferrite layer to offset the effects of electromagnetic shielding caused by the metal. Integrating a wire embedded antenna, a ferrite layer and adhesive layers into the card construction significantly impedes upon having a dual interface metal transaction card which has significant weight and a highly sophisticated appearance.

An example of a smartcard with contactless (or dual interface) capability, and having a metal layer and a ferrite layer may be found in US 2013/0126622 (204, FIG. 2A).

An example of a smartcard with contactless (or dual interface) capability, and having a metal layer with a slit in the metal layer may be found in U.S. Pat. No. 9,475,086.

It is therefore an object of the current invention to produce an RFID-enabled metal transaction card comprising a front face metal layer without a slit and a rear synthetic layer, operating in contactless mode from the rear side of the card body with an activation distance greater than (or at least) 4 cm and having drop acoustics which sound like metal.

There are a number of manufacturing challenges in producing RFID-enabled metal transaction cards having a slit or slits in the metal layers or metal card body to facilitate contactless functionality. The slit destabilizes the mechanical integrity and robustness of the card body and thus needs to be reinforced around the area of the discontinuity.

Also, inserting an electronic component such as an inductive coupling chip module into a metal card body and maintaining structural rigidity is a further card assembly challenge.

To accommodate the implanting of such a component into a metal transaction card, the metal is machined into various geometries in the x, y and z-axes, followed by insertion of the component into the machined cavity, recess or pocket. Prior to insertion, an adhesive tape is fixed to the component, and under temperature and pressure the sub-assembly is mounted into the card body.

In CNC machining around the area of a slit in a metal card body, there is a risk with ageing of the milling tool that the metal is smeared across the slit resulting in electrical shorting and impairing of the contactless functionality. Thus careful machining of the area around a slit in a metal card body and possibly filling the slit with a non-conductive material is a further manufacturing hurdle.

Some of these required machining geometries remove significant amounts of metal or leave slits, holes or slots in and through the card body which are aesthetically undesirable and weaken the mechanical robustness of the card body.

In order to mechanically strengthen the card body and provide a desirable surface finish, over-molding and insert molding techniques have been proposed in the prior art, but such techniques are difficult to implement in practice.

Furthermore, this innovation has improved RF performance over existing designs cited by the prior art because there is electrical isolation within the area of the slit or slits achieved through the encapsulation process, and it does not require excess removal of metal resulting in a loss of card body weight while maintaining the structural robustness and desired appearance.

Some Patents and Publications of Interest

The following patents and/or publications (“references”) may be of interest or relevant to the invention(s) disclosed herein, and some commentary may be provided to distinguish the invention(s) disclosed herein from the following references.

U.S. Pat. No. 9,836,684 (2017, Dec. 1; Finn et al.), incorporated by reference herein, discloses smart cards, payment objects and methods. Smartcards having (i) a metal card body (MCB) with a slit (S) overlapping a module antenna (MA) of a chip module (TCM) or (ii) multiple metal layers (M1, M2, M3) each having a slit (S1, S2, S3) offset or oriented differently than each other. A front metal layer may be continuous (no slit), and may be shielded from underlying metal layers by a shielding layer (SL). Metal backing inserts (MBI) reinforcing the slit(s) may also have a slit (S2) overlapping the module antenna. Diamond like coating filling the slit. Key fobs similarly fabricated. Plastic-Metal-Plastic smart cards and methods of manufacture are disclosed. Such cards may be contactless only, contact only, or may be dual-interface (contact and contactless) cards.

US 2018/0341847 (2018, Nov. 28; Finn et al.; now U.S. Pat. No. 10,552,722) discloses smartcard with coupling frame. Smartcard (SC) having a card body (CB) and a conductive coupling frame antenna (CFA) extending as a closed loop circuit around a periphery of the card body, and also extending inwardly so that two portions of the coupling frame antenna are closely adjacent each other, with a gap therebetween. The gap may extend from a periphery of the card body to a position corresponding with a module antenna (MA) of a transponder chip module (TCM) disposed in the card body, and may function like a slit (S) in a coupling frame (CF). A portion of the coupling frame antenna may be arranged to surround the ISO position of the transponder chip module in the card body. A coupling frame antenna (CFA) may be incorporated onto a module tape (MT) for a transponder chip module (TCM).

FIG. 2 of the '847 publication is a diagram of an exemplary coupling frame antenna (CFA) with a track width of approximately 3 mm. The design shown illustrates a continuous closed loop single track coupling frame antenna (CFA) 202 placed within the perimeter defined by the card body (CB) 201. It is noted that the figure is illustrative of the shape and overall form of the coupling frame antenna (CFA) 202 and that the antenna may reside upon or between any of the layers that may make up a typical smartcard. The outer edges of the coupling frame antenna (CFA) 402 may extend to the periphery of the card body (CB) 201 or be offset from the edge of the smartcard by some distance to aid lamination or other assembly of the smartcards additional layers. The path defined by the coupling frame antenna (CFA) 201 extends inwards towards and around the module opening (MO) 204. The length, width and track thickness of the coupling frame antenna (CFA) 202 in the vicinity of the module opening (MO) 204 may be set as to provide an optimum overlap with the module antenna (MA) of the transponder chip module (TCM).

The shape of the coupling frame antenna, as it extends inwardly from the left (as viewed) side of the card body to the module opening area, results in two side-by-side portions of the coupling frame antenna (CFA) being closely adjacent each other, with a gap therebetween. This gap may be comparable to the slit (S) in a conventional coupling frame (CF)

Generally, a “coupling frame” (CF) may comprise a metal layer, metal frame, metal plate or any electrically-conductive medium or surface with an electrical discontinuity such as in the form of a slit (S) or a non-conductive stripe extending from an outer edge of the layer to an inner position thereof, the coupling frame (CF) capable of being oriented so that the slit (S) overlaps (crosses-over) the module antenna (MA) of the transponder chip module (TCM), such as on at least one side thereof. The slit (S) may be straight, and may have a width and a length. In some embodiments, the slit (S) may extend to an opening (MO) for accepting the transponder chip module. In other embodiments, there may only be a slit, and no opening for the transponder chip module (TCM). Coupling frames of this type, typically a layer of metal with an opening for receiving a transponder chip module, and a slit extending from a periphery of the layer to the opening, wherein the slit overlaps at least a portion of the module antenna, may be found in the following U.S. Pat. Nos. 9,812,782; 9,390,364; 9,634,391; 9,798,968, and 9,475,086.

In contrast thereto, the coupling frame antenna (CFA) of the present invention may comprise a continuous conductive path or a track of wire or foil formed around the transponder chip module (TCM), such as by embedding wire or by etching a conductive path or track in the form of a one turn (or single-loop) antenna. The coupling frame may be planar or three dimensional (such as a curved surface). The coupling frame for inductive coupling with a reader may couple with either a passive or an active transponder chip module.

The path (or track) of the single-loop coupling frame antenna (CFA) may generally be around the periphery of the card body, but may extend to an inner position of the card body and double back on itself at selected areas of the card body, leaving a gap or void between the adjacent portions of the track. The space (void, gap) between closely-adjacent portions of the single-loop coupling frame may perform the function of a slit (S) in a conventional coupling frame—namely, overlap a portion of a module antenna in the transponder chip module—but it is distinctly different in construction. The coupling frame antenna (CFA) may wrap around the position (or module opening MO) for the transponder chip module (TCM).

Generally, the term “slit” will be applied to coupling frames (CF), and the term “space” will be applied to the corresponding feature of coupling frame antennas (CFA). However, in some instances, the term “slit” may be used to describe the space (void, gap) between closely-adjacent portions of the single-loop coupling frame antenna (CFA).

The overlap of the slit (or space) of either a coupling frame (CF) or a coupling frame antenna (CFA) with the module antenna (MA) may be less than 100%. In addition, the width and length of the slit (or space) can significantly affect the resonance frequency of the system and may be used as a tuning mechanism. As the width of slit (or space) changes, there is a resulting change in the overlap of the slit with the antenna.

Another distinction is important. When referring to a conventional overall coupling frame (CF) as being “continuous”, it should be understood that the slit (S) represents both a mechanical and an electrical discontinuity in an otherwise continuous (electrically and mechanically) structure. The slit is a feature extending from an edge of the coupling frame (CF) to an interior position thereof (typically, the module opening for the transponder chip module).

Most of the coupling frames described hereinbefore (such as in U.S. Pat. Nos. 9,812,782, 9,390,364, 9,634,391, 9,798,968, and 9,475,086) may have a “continuous” surface, and may comprise a foil or sheet or layer of metal having a slit (an electrical discontinuity) for overlapping a module antenna and, in some cases having an appropriate opening (MO) for accommodating mounting the transponder chip module. Coupling frames may be printed, and may be made up of a wire grid or array (such as wire embedding wire (copper or silver) and making a physical connection through overlapping wires to create a coupling frame. The coupling frame could also be a metal mesh. A “discontinuous” coupling frame could be made from a solid metal layer, or from embedding wire in a suitable pattern in a substrate, both of which would be arranged to exhibit a slit/discontinuity.

The coupling frame antenna (CFA) described herein is easily distinguishable from previous coupling frames (CF) in that it does not have a slit extending from an outer edge thereof to an inner position thereof, and is generally a continuous structure. It is within the scope of the invention, however, that the coupling frame antenna (CFA) may be broken (made to be discontinuous) at some point along its length, in which case it may be considered to be an “open-loop” antenna rather than a “closed-loop” antenna.

When considering the coupling frame antenna (CFA), in this manner, a closed-loop single-turn continuous-tract antenna with a folded/contour shape resulting in narrow spaces between closely-adjacent portions of the track can function as a coupling frame, the space in the contoured antenna serving the purpose of the slit in a coupling frame, both the slit and space preferably overlapping at least a portion of the module antenna in the transponder chip module. A benefit of the contoured antenna having a space, rather than a coupling frame having a slit is that the slit in the coupling frame is a mechanical discontinuity that may slightly compromise the mechanical integrity of the card. The contoured antenna does not suffer from this disadvantage, because there is no mechanical discontinuity in its single-loop structure.

Where the coupling frame antenna (CFA) 202 doubles back on itself, there is a space (gap, void) 203 between two closely-adjacent portions of the CFA. (This space may sometimes be referred to as a “slit”, as it performs a function similar to the slit of a CF, and may be labeled “S”.) The gap (S) 203 as shown extends from the outer perimeter of the coupling frame antenna (CFA) 202 and intersects the module opening (MO) 204. A device, for example and

LED or capacitor, may be connected across the gap (S) 203 or any other part of the coupling frame antenna (CFA) 202 in order to provide an additional function to the CFA 202 or to affect the resonance frequency of the device. Alternatively, the coupling frame antenna (CFA) 202 may be broken at some point to permit connection of a device which in turn completes the circuit of the coupling frame antenna and gives an effectively continuous track.

FIG. 2 of the '847 publication is a diagram, of an exemplary coupling frame antenna with a track width of 3 mm.

Notably, the coupling frame antenna (CFA) is a continuous track with no start or end, in short a closed loop circuit having a contour or form which wraps around or surrounds the position for the placement of a transponder chip module, having a module antenna which overlaps the coupling frame antenna on one side, two sides, three sides or on all four sides. The gap, slot, cut out, slit or opening does not cause an electrical discontinuity in the coupling frame antenna. The transponder chip module inductively couples with the coupling frame antenna through its module antenna harvesting the surface current distribution.

U.S. Pat. No. 9,697,459 (2017, Jul. 14; Finn et al.), incorporated by reference herein, discloses passive smart cards, metal cards, payment objects and smart jewelry. RFID devices comprising (i) a transponder chip module (TCM, 1410) having an RFIC chip (IC) and a module antenna (MA), and (ii) a coupling frame (CF) having an electrical discontinuity comprising a slit (S) or non-conductive stripe (NCS). The coupling frame may be disposed closely adjacent the transponder chip module so that the slit overlaps the module antenna. The RFID device may be a payment object such as a jewelry item having a metal component modified with a slit (S) to function as a coupling frame. The coupling frame may be moved (such as rotated) to position the slit to selectively overlap the module antennas (MA) of one or more transponder chip modules (TCM-1, TCM-2) disposed in the payment object, thereby selectively enhancing (including enabling) contactless communication between a given transponder chip module in the payment object and another RFID device such as an external contactless reader. The coupling frame may be tubular. A card body construction for a metal smart card is disclosed.

U.S. Pat. No. 5,550,402 (27 Aug. 1996; Nicklaus), incorporated by reference herein, discloses electronic module of extra-thin construction. An electronic module (M) of extra-thin construction. It is the principal object to substantially reduce the tendency to fracture of the module's semiconductor chip embedded in the plastic casing of the module (M), notwithstanding the extremely small thickness of the casing. The chip is fitted on the chip pad of a system support formed by a thin metal strip, commonly known as a lead frame. The chip may partly overlap the external contacts of the module that lie on one of the flat sides of the module's plastic casing. Slits in the system support, which form the boundaries of the chip pad and are inevitable lines of weakness in the thin metal strip, are situated at an oblique angle relative to the edges of the square or rectangular chip, preferably at about 45° degree.; hence the slits extend also at an oblique angle to possible fracture lines within the monocrystalline structure of the material used in chip manufacture, because said fracture lines are parallel to the chip's edges. Other slits in the metal strip, which extend from said boundary slits, should preferably also be at an angle relative to the edges of the chip. Further characteristics disclosed relate to the mechanical bond between parts of the system support and the module casing, and the bonding of the entire module (M) to the surrounding plastic material when it is molded into a supporting body or medium, for example in the manufacture of chip cards.

US 2019/0050706 (2019, Feb. 14; Lowe), incorporated by reference herein, discloses overmolded electronic components for transaction cards and methods of making thereof. A process for manufacturing a transaction card includes forming an opening in a card body of the transaction card; inserting an electronic component into the opening; and molding a molding material about the electronic component. A transaction card includes a molded electronic component.

U.S. Pat. No. 10,406,734 (10 Sep. 2019; Lowe), US 2019/0160717 (30 May 2019; CompoSecure; Lowe), US 2019/0291316 (26 Sep. 2019; CompoSecure; Lowe), incorporated by reference herein, disclose over-molded electronic components for transaction cards and methods of making thereof. A process for manufacturing a transaction card includes forming an opening in a card body of the transaction card; inserting an electronic component into the opening; and molding a molding material about the electronic component. A transaction card includes a molded electronic component.

US 2019/0286961 (19 Sep. 2019; Lowe), incorporated by reference herein, discloses RFID device. A process for manufacturing a transaction card includes forming an opening in a card body of the transaction card; inserting an electronic component into the opening; and disposing a non-conductive material about the electronic component. A transaction card includes a molded electronic component.

### SOME ADDITIONAL REFERENCES

The following US patents and patent application publications are referenced:

| | |
|---|---|
| 10,599,972 | (2020 Mar. 24; Finn et al.) |
| 10,552,722 | Smartcard with coupling frame antenna |
| 10,518,518 | (2019 Dec. 31; Finn et al.) |
| 10,248,902 | Coupling frames for RFID devices |
| 10,193,211 | Smartcards, RFID devices, wearables and methods |
| 9,960,476 | Smartcard constructions |
| 9,836,684 | Smartcards, payment objects and methods |
| 9,697,459 | Passive smartcards, metal cards, payment objects |
| 9,812,782 | Coupling frames for RFID devices |
| 9,390,364 | Transponder chip module with coupling frame on a |
| | common substrate |
| 9,489,613 | RFID transponder chip modules with a band of the |
| | antenna extending inward |
| 9,634,391 | RFID transponder chip modules |
| 9,622,359 | RFID transponder chip modules |
| 9,798,968 | Smartcard with coupling frame and method of increasing |
| | activation distance |
| 9,475,086 | Smartcard with coupling frame and method of increasing |
| | activation distance |
| 2018/0339503 | Smartcards with metal layers and methods of |
| | manufacture |
| 2018/0341846 | Contactless metal card construction |
| 2018/0341847 | Smartcard with coupling frame antenna |
| 2019/0114526 | Smartcard constructions and methods |
| 2019/0171923 | Metallized smartcard constructions and methods |
| 2019/0197386 | Contactless smartcards with multiple coupling frames |

U.S. Pat. No. 9,024,763 (5 May 2015; Hamedani Soheil) discloses arrangement comprising an object made at least partially of metal or precious metal and an RFID identification device. An arrangement including an object made at least partially of metal and/or precious metal and an RFID system, wherein the object and the RFID system are connected to one another in such a way that the transponder and the aerial of the RFID system are applied on a site of the object, on its surface, which is facing or can be caused to face an assigned reading device or are embedded into its surface in the form of an inlay, and means are provided which shield or attenuate the electrically conductive surface of the object against eddy currents induced in the conductor loop. Furthermore, the invention relates to a method for tracking and position-fixing objects of all kinds, which are made at least partially of metal and/or precious metal or are plated therewith, and into which a position-fixing device operating according to RFID technology is integrated. A transponder and, spaced apart from the latter, an aerial coupled with a reading device are disposed in or on the object at an application-specific conductive site and the transponder is shielded with respect to the conductive surface. Some claims of U.S. Pat. No. 9,024,763:
1. An arrangement comprising an object made at least partially of metal or precious metal comprising an electrically-conductive metallic surface having a top surface side and an RFID transponder for receiving energy from a reading device comprising a chip and an aerial structure, the chip and aerial structure are connected to one another and are directly embedded onto a substrate layer of the RFID transponder, wherein the substrate layer of the RFID transponder is directly integrated into the top surface side of the electrically-conductive metallic of the object made at least partially of metal or precious metal thereby enabling the RFID transponder to receive the energy from the reading device, wherein the RFID transponder is directly placed into a recess on the top surface side of the electrically-conductive metallic surface of the object and is disposed flush with the top surface side of the electrically-conductive metallic surface of the object made at least partially of metal or precious metal, wherein the substrate layer comprises a plurality of fixed, highly permeable ferromagnetic particles in a region of a spatial extension of the aerial structure of the RFID transponder on a top surface facing the electrically-conductive metallic surface, where the plurality of fixed, highly permeable ferromagnetic particles are oriented in such a way, that after being fixed-on a top surface of the substrate layer, the plurality of fixed, highly permeable ferromagnetic particles lie parallel to a magnetic field induced in the aerial structure of the RFID transponder and thereby suppress eddy currents, which occur when the RFID transponder is introduced into the magnetic field induced by a the corresponding reading device and wherein disposed between the highly permeable ferromagnetic particles are free spaces, which act as air gaps and wherein the substrate layer is a highly permeable material and wherein the object is an access card, a chip card or a card made of precious metal with RFID technology.
5. The arrangement according to claim 1, wherein the aerial structure is a conductor loop in the form of a UHF aerial, which is configured as a dipole, or an HF aerial, and which is configured as an induction loop.

U.S. Pat. No. 9,390,366 (12 Jul. 2016; Herslow et al.) discloses metal smart card with dual interface capability. A dual interface smart card having a metal layer includes an IC module, with contacts and RF capability, mounted on a plug, formed of non RF impeding material, between the top and bottom surfaces of the metal layer. The plug provides support for the IC module and a degree of electrical insulation and isolation from the metal layer. The resultant card can have contact and contactless operating capability and an entirely smooth external metal surface except for the contacts of the IC module.

U.S. Pat. No. 9,721,200 (1 Aug. 2017; Herslow et al.) discloses card with metal layer and an antenna. A smart card having an antenna structure and a metal layer, in which an insulator layer is formed between the antenna structure and the metal layer to compensate for the attenuation due to the metal layer. The thickness of the insulator layer affects the capacitive coupling between the antenna structure and the metal layer and is selected to have a value which optimizes the transmission/reception of signals between the card and a card reader.

U.S. Pat. No. 9,898,699 (20 Feb. 2018; Herslow et al.) discloses smart metal card with radio frequency (RF) transmission capability. Ferrite material utilized in a smart metal card as a shield between a metal layer and an antenna does not occupy a complete layer. Instead, only sufficient ferrite material is utilized to track and conform to the antenna.

U.S. Pat. No. 10,089,570 (2 Oct. 2018; Herslow et al.) discloses card with metal layer and an antenna. A smart card having an antenna structure and a metal layer, in which an insulator layer is formed between the antenna structure and the metal layer to compensate for the attenuation due to the metal layer. The thickness of the insulator layer affects the capacitive coupling between the antenna structure and the metal layer and is selected to have a value which optimizes the transmission/reception of signals between the card and a card reader.

U.S. Pat. No. 10,275,703 (30 Apr. 2019; Herslow et al.), incorporated by reference herein, discloses smart metal card with radio frequency (RF) transmission capability. RF shielding material utilized in a smart metal card as a shield between a metal layer and an antenna does not occupy a complete layer. Instead, only sufficient RF shielding material is utilized to track and conform to the antenna.

U.S. Pat. No. 10,289,944 (14 May 2019; Herslow et al.), incorporated by reference herein, discloses metal smart card with dual interface capability. A dual interface smart card having a metal layer includes an SC module, with contacts and RF capability, mounted on a plug, formed of non RF impeding material, between the top and bottom surfaces of the metal layer. The plug provides support for the IC module and a degree of electrical insulation and isolation from the metal layer. The resultant card can have contact and contactless operating capability and an entirely smooth external metal surface except for the contacts of the IC module.

U.S. Pat. No. 10,318,859 (11 Jun. 2019; Lowe, et al.) discloses dual interface metal smart card with booster antenna. A card having a metal layer and an opening or cut-out region in the metal layer, with a dual-interface integrated circuit (IC) module disposed in the opening or cut-out region. A ferrite layer is disposed below the metal layer and a booster antenna is attached to the ferrite layer. A vertical hole extends beneath the IC module through the ferrite layer. The booster antenna may be physically connected to the IC module or may be configured to inductively couple to the IC module. In some embodiments, the IC may be disposed in or on a non-conductive plug disposed within the opening or cut-out region, or the vertical hole may have a non-conductive lining, or a connector may be disposed between the booster antenna and the IC module in the vertical hole.

U.S. Pat. No. 10,534,990 (14 Jan. 2020; Lowe, et al.) discloses metal Smart Card with Dual Interface Capability. A dual interface smart card, and methods for the manufacture thereof, having a metal layer, an IC module, with contacts and RF capability, and a plug formed of non RF impeding material, disposed in the metal layer. The plug provides support for the IC module and a degree of electrical insulation and isolation from the metal layer. Embodiments of the card include at least one additional layer.

US 2019/0354825 (21 Nov. 2019; Lowe) discloses metal dual interface card. A dual interface transaction card which includes a metal card body having first and second surfaces. A contact-only transaction module is secured in the card body, the contact-only transaction module including contact pads disposed on the first surface of the card body and including a first transaction circuit. A contactless transaction module is secured in a void in the metal card body. The contactless transaction module includes a second transaction circuit and an antenna. Also disclosed is a process for manufacturing the dual interface transaction card. The process includes the steps of constructing a metal card body having the first and second surfaces, securing the contact-only transaction module in the metal card body, forming the void in the metal card body, and securing the contactless transaction module in the void.

U.S. Pat. No. 10,445,636 (15 Oct. 2019; Virostek et al.) discloses interference-optimized metal data carrier. A layer arrangement is provided for manufacturing an interference-optimized, metal and card-shaped data carrier and to a layer laminate comprising the layer arrangement. As claimed therein:
A layer arrangement for manufacturing an interference-optimized, metal and card-shaped data carrier, comprising: a metal layer for stabilizing a card body; a shielding layer for reducing interference which results from interaction between the metal layer and the operation of an antenna; and an antenna layer for receiving the antenna, wherein the shielding layer is arranged between the metal layer and the antenna layer, and wherein the shielding layer completely covers the metal layer on a first side.

US 2019/0311235 and US 2019/0311236 (10 Oct. 2019; Sexl et al.) discloses portable dual-interface data carrier with metal frame. A portable dual-interface data carrier contains a metal sheet which can be provided with low technical effort and especially no ferrite material is required. The resulting portable dual-interface data carrier is more heavy than a state of the art PVC smart card and provides contact based interface on one side, whereas contactless interfaces is working from both sides of the card. One application domain of the data carrier is to provide a so-called smartcard. The present invention is furthermore directed towards a dual-interface module as well as towards a method for providing a portable dual-interface data carrier. Moreover, a data carrier is suggested comprising instructions for performing the suggested method and for manufacturing the portable dual-interface data carrier.

PCT/US2019/020919 (12 Sep. 2019; Cox) discloses metal card. A card core which includes a body defining a cutout and a discontinuity. The cutout includes an opening in the body defined by an edge and the discontinuity includes a channel defined by the body extending from an outer surface of the body to the cutout. At least one circuit element is positioned within the cutout. The cutout defines a size and geometry such that a gap is defined between the at least one circuit element and the edge to electromagnetically isolate the at least one circuit element from the body.

US 2013/0126622 (23 May 2013; Finn) discloses offsetting shielding and enhancing coupling in metallized smart cards. A dual-interface smart card having a booster antenna with coupler coil in its card body, and a metallized face plate having a window opening for the antenna module. Performance may be improved by one or more of making the window opening substantially larger than the antenna module, providing perforations through the face plate, disposing ferrite material between the face plate and the booster antenna. Additionally, by one or more of modifying contact pads on the antenna module, disposing a compensating loop under the booster antenna, offsetting the antenna module with respect to the coupler coil, arranging the booster antenna as a quasi-dipole, providing the module antenna with capacitive stubs, and disposing a ferrite element in the antenna module between the module antenna and the contact pads.

US 2015/0269477 (24 Sep. 2015; Finn et al.) discloses dual-interface hybrid metal smartcard with a booster antenna or coupling frame. A dual-interface metal hybrid smartcard comprising a plastic card body (CB); a metal slug (MS) disposed in the card body; and a booster antenna (BA) disposed in the card body. The metal slug may have a surface area which is at least 50% of a surface area of the card body, and may comprise titanium or alloys thereof. A antenna chip module (AM) having an antenna (MA) and contact pads (CP) may be disposed in an opening of the card body. The metal slug may comprise two or more separate metal slug components (MS-1, MS-2), which may overlap one another or which may be disposed at different locations in the card body (CB), without overlapping one another. The first metal slug component (MS-1) may be disposed around a peripheral portion of the card body (CB) as an “open loop” discontinuous metal frame around (external to) the booster antenna (BA). The second metal slug component (MS-2) may be disposed internal to the card antenna (CA) component of the booster antenna (BA).

### Some Definitions

Some of the following terms may be used or referred to, herein.

RFID Slit Technology

“RFID Slit Technology” refers to modifying a metal layer or a metal card body (MCB) into a so-called “antenna circuit” by providing a discontinuity in the form of a slit, slot or gap in the metal layer or metal card body (MCB) which extends from a peripheral edge to an inner area or opening in the layer or card body. The concentration of surface current at the inner area or opening can be picked up by another antenna (such as a module antenna) or an antenna circuit by means of inductive coupling which can drive an electronic circuit such as an RFID chip attached directly or indirectly thereto. The slit may be ultra-fine (typically less than 50 μm or less than 100 μm), cut entirely through the metal with a UV laser, with the debris from the plume removed by ultrasonic or plasma cleaning. Without a cleaning step after lasing, the contamination may lead to shorting across the slit. In addition, the slit may be filled with a dielectric to avoid such shorting during flexing of the metal forming the transaction card. The laser-cut slit may be further reinforced with the same filler such as a resin, epoxy, mold material, repair liquid or sealant applied and allowed to cure to a hardened state or flexible state. The filler may be dispensed or injection molded. The term “slit technology” may also refer to a “coupling frame” with the aforementioned slit, or to a smartcard embodying the slit technology or having a coupling frame incorporated therein.

Providing a metal layer in a stack-up of a card body, or an entire metal card body, to have a module opening for receiving a transponder chip module (TCM) and a slit (S) to improve contactless (RF) interface with the card—in other words, a “coupling frame”—may be described in greater detail in U.S. Pat. Nos. 9,475,086, 9,798,968, and in some other patents that may be mentioned herein. In some cases, a coupling frame may be formed from a metal layer or metal card body having a slit, without having a module opening. A typical slit may have a width of approximately 100 μm. As may be used herein, a “micro-slit” refers to a slit having a smaller width, such as approximately 50 μm, or less.

Booster Antenna

A booster antenna comprises of a set of coils which includes a perimeter coil, a coupler coil and in some instances an extension coil. The coils may be wound (wire embedded), or chemically etched. As depicted in the prior art, the coils have multiple turns or windings (plural).

Injection Molding

It is a manufacturing process for producing parts by injecting molten material into a mold. Injection molding can be performed with a host of materials mainly including metals (for which the process is called die-casting), glasses, elastomers, confections, and most commonly thermoplastic and thermosetting polymers. Material for the part is fed into a heated barrel, mixed (using a helical shaped screw), and injected into a mold cavity, where it cools and hardens to the configuration of the cavity.

Multi-Material Injection Molding (MMM)

It is the process of molding two or more different materials into one plastic part at one time. As is the case in traditional injection molding, multi material injection molding uses materials that are at or near their melting point so that the semi-liquidous (viscous) material can fill voids and cavities within a pre-machined mold, thus taking on the desired shape of designed tooling. The three most widely used methods of MMM fabrication are: multi-component injection molding, multi-shot injection molding and over-molding.

Over-Molding

It is effectively the use of layering effects in polymer application techniques. This process is centered around the use of a liquidous resin to add additional layers of shape and structure to an existing component. An example of such a resin could be a polymer that has been heated to a temperature just above its glass transition temperature. The existing component to which the resin is being added is often injection molded as well, and may be near its own glass transition temperature. This process works well when layers with varying geometric profiles are desired around a central “core” structure.

Transfer Molding

It is a manufacturing process where casting material is forced into a mold. Transfer molding is different from compression molding in that the mold is enclosed [Hayward] rather than open to the fill plunger resulting in higher dimensional tolerances and less environmental impact. Compared to injection molding, transfer molding uses higher pressures to uniformly fill the mold cavity. This allows thicker reinforcing fiber matrices to be more completely saturated by resin. Furthermore, unlike injection molding the transfer mold casting material may start the process as a solid. This can reduce equipment costs and time dependency. The transfer process may have a slower fill rate than an equivalent injection molding processes.

### SUMMARY

The invention may relate to innovations in or improvements to RFID-enabled metal-containing transaction cards.

It is an object of the invention to substantially reduce the thickness of the RF antenna and the amount of ferrite material utilized in a transaction card, while at the same time maximizing the thickness of the metal layer to improve the prestige and aesthetic aspect of these cards. This is applicable to transaction cards having contactless or dual interface capability.

According to the invention, generally, a transaction card may have a front “continuous” (with no slit) metal layer (530, 630, 730) with an opening (506, 612, 712) for a dual-interface transponder chip module (510, 610, 710). A shielding layer (540, 640, 742) comprising ferrite material disposed below the metal layer. An amplifying element (507, 650, 744) disposed under the shielding layer. A metal interlayer (750, FIG. 7B) with a slit to function as a coupling frame (CF). A coupling frame antenna (507) having a single turn or track mounted on a supporting substrate (502). A rear plastic layer (560, 660, 760) formed of non-RF impeding material may capture a magnetic stripe and security elements (signature panel and hologram). The coupling frame antenna 507 may be integrated into the rear plastic layer. A portion of the front metal layer may protrude downward into the shielding layer. A dielectric spacer (548, 648, 748) may be disposed between the shielding layer and the amplifying element. The amplifying element may be a coupling frame antenna (CFA; 507), a coupling frame (CF; 650), or a booster antenna circuit (BAC; 744).

Ferrite material may be utilized in the transaction card as an RF shield (shielding layer) between the metal layer and the coupling frame antenna (CFA) and may not occupy a complete layer. Rather, only sufficient ferrite material may be utilized to conform to the single turn or track of the coupling frame antenna. The coupling frame antenna may be physically connected to the transponder chip module either in series or parallel with its module antenna. A capacitor may be assembled and connected in series or parallel with the coupling frame antenna and its connection to the circuitry of the transponder chip module.

The smartcards (transaction cards) disclosed herein may be “one-sided”, in that they may only operate contactlessly when the back (rear) side of the card is presented to an external reader, such as a contactless POS (point of sale) terminal. The front of the card has a continuous metal layer, without a slit, and therefore cannot function well contactlessly. A shielding layer and an amplifying element may be disposed behind the front metal layer to enable contactless functionality when the back side of the card is presented to the reader.

A process for manufacturing a transaction card may include mechanically milling a pocket cavity or recess in the card body, filling the area with a non-conductive or ferromagnetic compound, mechanically forming said compound to have a certain shape and depth, and implanting an electronic component in the formed compound. To avoid electrical shorting of a slit during CNC milling caused by tool degradation resulting in metal smearing across the slit, the termination ends of the slit commencing at the perimeter edge of the metal card body and finishing at the module opening are laser cut to have a wider form.

According to some embodiments (examples) of the invention, the card body of a smartcard may comprise a stackup of layers, including: a front metal layer (730) having a first module opening (MO; 712); a shielding layer (742) disposed behind the front metal layer; a booster antenna circuit (BAC; 744) disposed behind the shielding layer; and a metal interlayer or layers (750) each having a second module opening (714) and a slit (720). Notably, the front metal layer does not have a slit extending from a peripheral edge of the front metal layer to the first module opening. A dielectric spacer (738) may be disposed between the front metal layer and the shielding layer. The metal interlayer or layers may be disposed behind the booster antenna circuit. Alternatively, the metal interlayer or layers may be disposed between the front metal layer and the booster antenna circuit. A protective hard coat layer (724) may be disposed on the front metal layer. A print layer (726) may be disposed between the hard coat layer and the front metal layer. A transparent, translucent or white synthetic layer (760) may be disposed behind the metal interlayer or layers. At least one of primer (762) and ink (764) may be disposed on the synthetic layer. A laser engravable overlay layer (770) may be disposed behind the synthetic layer. A dual-interface module (710) may be inserted into the module openings of the card body.

According to some embodiments (examples) of the invention, a transaction card having at least contactless capability may comprise: a dual interface transponder chip module (TCM; 500A,B) having a dual interface RFID chip and a module antenna; a metal layer (530) having a module opening (506) and no slit extending from a peripheral edge of the front metal layer to the first module opening; a radio frequency shielding layer (540) comprising ferrite material disposed behind the metal layer; a coupling frame antenna (CFA) on a support substrate (502) disposed behind the shielding layer and comprising a single turn or track having a slit or gap extending from an outer edge of the coupling frame antenna to an inner position thereof, wherein the slit or gap of the coupling frame antenna is disposed to overlap at least a portion of the module antenna. At least one plastic layer (560) may be disposed behind the support substrate. A magnetic stripe and security elements may be disposed on the plastic layer. The card may further comprise a second coupling frame antenna having a slit or gap extending from an outer edge of the coupling frame antenna to an inner position thereof, and stacked with the coupling frame antenna; and a dielectric layer disposed between the coupling frame antenna and the second coupling frame antenna. The slit may be disposed to overlap at least a portion of the module antenna. The coupling frame antenna may be configured to inductively couple to the dual interface transponder chip module. The coupling frame antenna may be physically connected in series or parallel with the module antenna of the dual interface transponder chip module. The coupling frame antenna may be physically connected to pads linked to antenna connections La and Lb on the dual interface chip.

According to some embodiments (examples) of the invention, an RFID-enabled metal transaction card may comprise: a front face metal layer (ML; 530, 630, 730) with a module opening for a chip module, and without a slit extending from a peripheral edge of the front metal layer to the module opening, wherein the card is capable of operating in contactless mode from the rear side of the card body. The card may further comprise a rear synthetic layer (560, 660, 760). The card may have an activation distance of at least 4 cm. The card may have drop acoustics which sound like metal. The card may further comprise a shielding layer (540, 640, 742) disposed behind the front metal layer; and an amplifying element (CFA, CF, BAC) disposed behind the shielding layer.

According to some embodiments (examples) of the invention, a card body for a smartcard may comprise: a front metal layer (630) having a module opening (MO; 612); a shielding layer (640) disposed behind the front metal layer; and a coupling frame (CF; 650) disposed behind the shielding layer; wherein the front metal layer does not have a slit extending from a peripheral edge of the front metal layer to the module opening. A dielectric spacer (638) may be disposed between the front metal layer and the shielding layer. A protective hard coat layer 624) may be disposed on the front metal layer. A print layer (626) may be disposed between the hard coat layer and the front metal layer. A transparent, translucent or white synthetic layer (660) may be disposed behind the metal interlayer or layers. At least one of primer (662) and ink (664) may be disposed on the synthetic layer. A laser engravable overlay layer (670) may be disposed behind the synthetic layer. A dual-interface module (610) may be inserted into the module openings of the card body.

According to some embodiments (examples) of the invention, a process for manufacturing an RFID-enabled metal transaction card may comprise the steps of: CNC milling an opening in a card body of the transaction card; filling the opening partially or entirely with a compound; mechanically forming the compound as a structure having the shape and dimensions of an electronic component; and inserting the electronic component into the formed compound structure. The step of forming the compound may comprise: applying an ultrasonic tool or hot stamp to the compound under pressure and temperature to compress and shape the compound to accept the insertion of the electronic component. The step of inserting the electronic component may comprise: placing the electronic component with an adhesive backing layer into the formed compound using heat and pressure. The step of inserting the electronic component may be performed after the step of forming the compound. The process of may further comprise the step of: creating one or more securing features in the card body for securing the formed compound material to the card body. The securing features may comprise pockets in the card body. A CNC milled opening may extend partially or entirely through the card body. The compound material may be an epoxy resin having a forming temperature range which can withstand high paint bake temperatures of approximately 300-400° F.

One aspect of the invention is a transaction card having a length, a width, and a thickness, with a substantial portion of the volume occupied by an edge-to-edge metal layer (ML).

According to the invention, generally a transaction card may have a “continuous” metal layer (i.e., a metal layer with no slit) and an opening in the metal layer, with a dual-interface transponder chip module disposed in said opening. A radio frequency shielding layer, comprising ferrite material and an insulating layer, is disposed below the metal layer. The RF shielding layer and metal layer are attached by means of an adhesive layer.

A coupling frame antenna (CFA) having a single turn or track is mounted on a supporting substrate and is attached to the shielding layer by means of an adhesive layer. Note that the prior art always mentions turns and windings in the plural. The CFA disclosed herein has only one turn or track.

Ferrite material utilized in the transaction card as an RF shield between the metal layer and the coupling frame antenna may not occupy a complete layer. Instead, only sufficient ferrite material may be utilized to conform to the single turn or track of the coupling frame antenna. The coupling frame antenna may be physically connected to the transponder chip module either in series or parallel with the micro-antenna (module antenna) or physically connected to the pads linking the Lₐ and L_{b} (antenna) terminals of the dual interface chip module or alternatively may be configured to inductively couple with the chip module by overlapping a micro-antenna (module antenna) on the face-down side of the transponder chip module. A capacitor may be assembled and connected in series or parallel with the coupling frame antenna and its connection to the circuitry of the transponder chip module, or vice-versa. A rear plastic layer formed of non-RF impeding material may capture (support) a magnetic stripe and the security elements (signature panel and hologram). The coupling frame antenna may be integrated into said rear plastic layer.

According to an embodiment of the invention a transaction card may comprise a front face metal layer (ML) with no slit (S) and a rear plastic layer; an opening (MO) in the front face metal layer for accepting a dual interface transponder chip module (TCM) extending from the top metal surface to the rear plastic layer; a shielding layer (SL) of suitable magnetic material such as ferrite on an insulating layer disposed below the metal layer (ML) and using an adhesive layer for attachment thereto; a booster antenna circuit (BAC) is assembled on the shielding layer (SL) for enhancing RF transmission with the dual interface transponder chip module; the booster antenna circuit may be configured to inductively couple with the module antenna (MA) on the face down-side of the dual interface transponder chip module (TCM) or may be physically connected to the dual interface transponder chip module; an inter metal layer with a slit to function as a coupling frame or as a coupling frame antenna may operate in conjunction with the booster antenna circuit (BAC) to amplify the power delivery to the chip; an adhesive layer may bond and separate the booster antenna circuit from the inter metal layer; the rear plastic layer to capture the security elements and magnetic stripe may be adhesively attached to the underside of the inter metal layer to form the complete card body.

The invention may relate to innovations in or improvements to electronic components housed or encapsulated in RFID-enabled metal transaction cards.

It is an object of the invention to encapsulate an area within a metal card body and form said area to accept the insertion of an electronic component, with the encapsulation process filling the area around the slit or slits, while at the same time strengthening the card body geometries.

According to an embodiment of the invention, a recess is mechanically milled in the card body of a metal transaction card, and the resulting recess is partially or fully filled with a non-conductive compound or ferromagnetic compound and formed under pressure and temperature to a shape matching the dimensions of an electronic component.

According to an embodiment of the invention, a slit or slits in a metal layer or inter metal layer of a metal transaction card are filled with the compound to electrically isolate the metal edges of the slit or slits. The slit may be widened at its start and end position to avoid smearing of the metal around the area of the slit during CNC milling, and thus preventing shorting of the slit at its end positions.

According to an embodiment of the invention, the compound filled slits in a metal card body may be coated in a paint-bake process at elevated temperatures with color paint and lacquer thus disguising the presence of the slit. The surface finish can be further protected with a hard coat layer during lamination of the synthetic layers to the metal layer or layers.

According to an embodiment of the invention, a metal foil hologram may be directly hot stamped to the hard coat layer. To engrave a logo, a picosecond laser may be used to ablate the hard coat, lacquer, paint, and metal layers. Overprinting of the hard coat layer with a digitally deposited hard ink is a further embodiment of the invention.

In their various embodiments, the invention(s) described herein may relate to industrial and commercial industries, such RFID applications, payment transaction cards (metal, ceramic, plastic or a combination thereof), electronic credentials, identity cards, loyalty cards, access control cards, and the like.

Other objects, features and advantages of the invention(s) disclosed herein may become apparent in light of the following illustrations and descriptions thereof.

### BRIEF DESCRIPTION OF THE DRAWINGS

Reference will be made in detail to embodiments of the disclosure, non-limiting examples of which may be illustrated in the accompanying drawing figures (FIGs). The figures may generally be in the form of diagrams. Some elements in the figures may be stylized, simplified or exaggerated, others may be omitted, for illustrative clarity.

Although the invention is generally described in the context of various exemplary embodiments, it should be understood that it is not intended to limit the invention to these particular embodiments, and individual features of various embodiments may be combined with one another. Any text (legends, notes, reference numerals and the like) appearing on the drawings are incorporated by reference herein.

Some elements may be referred to with letters (“AS”, “CBR”, “CF”, “MA”, “MT”, “TCM”, etc.) rather than or in addition to numerals. Some similar (including substantially identical) elements in various embodiments may be similarly numbered, with a given numeral such as “310”, followed by different letters such as “A”, “B”, “C”, etc. (resulting in “310A”, “310B”, “310C”), and may collectively (all of them at once) referred to simply by the numeral (“310”).

FIG. 1A (compare FIG. 1 of 62/932,506; FIG. 3A of U.S. Pat. No. 10,275,703) is a cross-sectional diagram of a smart metal card with ferrite shield formed between the card and chip antennas and the cards' metal layer, according to the prior art.

FIG. 1B (compare FIG. 2 of 62/932,506; FIG. 6B of U.S. Pat. No. 10,275,703) is a simplified partial cross-sectional view of a dual interface smart card, according to the prior art.

FIG. 1C (compare FIG. 4 of 62/932,506; FIG. 4 of U.S. Pat. No. 10,318,859) is a cross-sectional diagram of the layers of a metal-containing card body with booster antenna and shielding layer, according to the prior art.

FIG. 2 (compare FIG. 3 of 62/932,506; FIG. 16B of U.S. Pat. No. 9,836,684) is a diagram (exploded perspective view) of a shielded metal laminated smartcard (RFID device), according to the prior art.

FIGS. 3A, B (compare FIGS. 1A, B of 62/964,138; FIGS. 5A and 5B of U.S. Pat. No. 9,697,459) are two perspective views (front and back) of a metal card body MCB having a cavity (MO) for a transponder chip module (TCM, not shown), and a slit S extending from the cavity to an outer edge of the metal card body, according to the prior art.

FIG. 3C (compare FIG. 2 of 62/964,138; FIG. 3 of U.S. Pat. No. 5,550,402) is part details of consecutive stages of manufacture of an electronic module, based on a system support, according to the prior art.

FIG. 4A (compare FIG. 3A of 62/964,138; FIG. 3A of US 2019/0050706) is a schematic illustration of the front of a transaction card prior to insertion molding, according to the prior art.

FIG. 4B (compare FIG. 3B of 62/964,138; FIG. 3B of US 2019/0050706) is a schematic illustration of the rear of a transaction card prior to insertion molding, according to the prior art.

FIG. 4C (compare FIG. 3C of 62/964,138; FIG. 3C of US 2019/0050706) is a schematic illustration of the front of a transaction card after insertion molding, according to the prior art.

FIG. 4D (compare FIG. 3D of 62/964,138; FIG. 3D of US 2019/0050706) is a schematic illustration of the rear of a transaction card after insertion molding, according to the prior art.

FIG. 5A (compare FIG. 5 of 62/932,506) is a diagram (exploded perspective view) of a shielded metal laminated transaction card with a coupling frame antenna (CFA), according to an embodiment of the invention.

FIG. 5B is a modified diagram of FIG. 5A with additional features showing the stack-up construction of a dual interface metal face smartcard with contactless tap to pay function on one side of the card body, according to an embodiment of the invention.

FIG. 6A is a diagram (exploded perspective view) of the stack-up construction of a dual interface metal face smartcard with contactless tap to pay function on one side of the card body having a metal interlayer with slit to function as a coupling frame (CF), according to an embodiment of the invention.

FIG. 6B is a modified diagram of FIG. 6A showing a stack-up construction of a dual interface metal face smartcard with contactless tap to pay function on one side of the card body, having a front face solid metal layer without a discontinuity with its rear surface having an off-center protruding metal section, according to an embodiment of the invention.

FIG. 6C is a modified diagram of FIG. 6B showing the stack-up construction of a dual interface metal face smartcard with contactless tap to pay function on one side of the card body, having a front face solid metal layer without a discontinuity attached to an underlying frame of anti-shielding material, according to an embodiment of the invention.

FIG. 7A is a diagram (exploded perspective view) of the stack-up construction of a dual interface metal face smartcard with contactless tap to pay function on one side of the card body having a booster antenna circuit (BAC) in combination with an underlying metal interlayer having a slit to function as a coupling frame or coupling frame antenna, according to an embodiment of the invention.

FIG. 7B is a similar diagram to FIG. 7A showing the stack-up construction of a dual interface metal face smartcard with contactless tap to pay function on one side of the card body having a metal interlayer with a slit to function as a coupling frame or a coupling frame antenna, above an underlying ferrite layer having a booster antenna circuit, with the top coupling frame and bottom booster antenna circuit sandwiching a ferrite layer, according to an embodiment of the invention.

FIG. 8A (compare FIG. 4 of 62/964,138) is a side view of a transaction card showing a metal card body with an opening to accept the implanting of an inductive coupling chip module and the corresponding dimensions thereof with a rear synthetic layer (laser engravable overlay) capturing the security elements (not shown), and ready for lamination to the metal layer, according to an embodiment of the invention.

FIG. 8B (compare FIG. 5 of 62/964,138) is a side view of a transaction card showing a metal card body with the opening to accept the implanting of the inductive coupling chip module and the synthetic layer laminated to the metal layer, according to an embodiment of the invention.

FIG. 8C (compare FIG. 6 of 62/964,138) is a side view of a transaction card showing a metal card body with the opening filled with a compound and cured to a solid state, according to an embodiment of the invention.

FIG. 8D (compare FIG. 7 of 62/964,138) is a side view of a transaction card embodying the invention showing a metal card body with the compound structure machined to have a recess area matching the shape and dimensions of the inductive coupling chip module, according to an embodiment of the invention.

FIG. 8E (compare FIG. 8 of 62/964,138) is a side view of a transaction card showing a metal card body with an inductive coupling chip module implanted in the machined recessed area having interior walls composed of the compound structure, according to an embodiment of the invention.

FIG. 9A (compare FIG. 9 of 62/964,138) is a front elevation view of a transaction card embodying the invention showing a slit commencing at a perimeter edge of the metal card body and terminating at the inductive coupling chip module, with the slit exhibiting a semi-circle opening shape at both ends of the slit, according to an embodiment of the invention.

FIG. 9B (compare FIG. 10 of 62/964,138) is a front elevation view of a transaction card embodying the invention showing a slit commencing at a perimeter edge of the metal card body and terminating at the inductive coupling chip module, with the slit exhibiting a delta (triangular) opening shape at both ends of the slit, according to an embodiment of the invention.

### DESCRIPTION

Various embodiments (or examples) may be described to illustrate teachings of the invention(s), and should be construed as illustrative rather than limiting. It should be understood that it is not intended to limit the invention(s) to these particular embodiments. It should be understood that some individual features of various embodiments may be combined in different ways than shown, with one another. Reference herein to “one embodiment”, “an embodiment”, or similar formulations, may mean that a particular feature, structure, operation, or characteristic described in connection with the embodiment is included in at least one embodiment of the present invention. Some embodiments may not be explicitly designated as such (“an embodiment”).

The embodiments and aspects thereof may be described and illustrated in conjunction with systems, devices and methods which are meant to be exemplary and illustrative, not limiting in scope. Specific configurations and details may be set forth in order to provide an understanding of the invention(s). However, it should be apparent to one skilled in the art that the invention(s) may be practiced without some of the specific details being presented herein.

Furthermore, some well-known steps or components may be described only generally, or even omitted, for the sake of illustrative clarity. Elements referred to in the singular (e.g., “a widget”) may be interpreted to include the possibility of plural instances of the element (e.g., “at least one widget”), unless explicitly otherwise stated (e.g., “one and only one widget”).

In the following descriptions, some specific details may be set forth in order to provide an understanding of the invention(s) disclosed herein. It should be apparent to those skilled in the art that these invention(s) may be practiced without these specific details. Any dimensions and materials or processes set forth herein should be considered to be approximate and exemplary, unless otherwise indicated. Headings (typically underlined) may be provided as an aid to the reader, and should not be construed as limiting.

Reference may be made to disclosures of prior patents, publications and applications. Some text and drawings from those sources may be presented herein, but may be modified, edited or commented to blend more smoothly with the disclosure of the present application.

Dual Interface Metal Cards with a Ferrite Layer

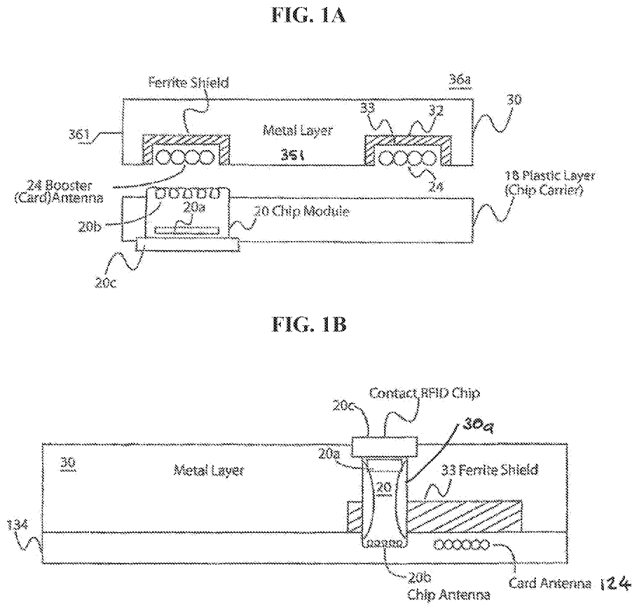

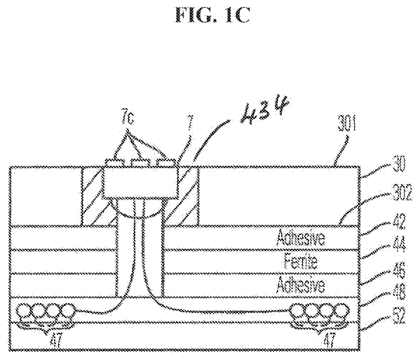

FIG. 1A includes a sectional view of metal substrate 30 having an exterior (outer) surface 361 and an inner surface 351. After groove 32 is formed on the inner surface 351, ferrite material 33 and an adhesive such as epoxy, cyanoacrylate, silicone based system or thermoplastic adhesive are applied into the channel defined by the groove 32. The ferrite 33 may be applied as a die cut sheet or as a ferrite slurry acrylic oligomer intermediate which will harden under UV exposure or after the slurry solvent is driven off. It should be noted that the ferrite 33 is preferably applied so as to be below the inner surface of the substrate 30 and to rise up to the surface of the card at the edges of groove 32. Note the antenna wires cannot be completely encased or completely shielded by the ferrite layer. That is the ferrite shield cannot completely surround the antenna.

The ferrite shield 33 overlies card (booster) antenna 24. A plastic layer 18 is formed below subassembly 36a. Layer 18 contains and includes a module 20, which contains a microprocessor chip 20a and a chip antenna 20b coupled to chip 20a.

Note that contact pad 20c is on the opposite side of the metal substrate.

In operation, ferrite material 33 deposited in groove 32 shields antenna 24 (and chip antenna 20b) from metal substrate 30, to make it possible for RF radiation to enter and be emitted from antenna 24.

A metal surface interferes with RF radiation in that it absorbs incident RF signals with the metal acting as a virtual ground. The ferrite layer formed between the card antenna 24 (including chip antenna 20b) and the metal layer 30 reflects incident RF signals so they are not absorbed by the metal layer.

Note that a reader (not shown) would be positioned to interrogate the smart card from the non-metallic side of the card for contactless operation.

As set forth in some claims of U.S. Pat. No. 10,275,703:
1. A metal smart card comprising: a plastic layer having a top surface; a metal layer overlying the plastic layer, said metal layer having an inner surface; a groove formed within the inner surface of said metal layer; a card antenna comprising antenna windings disposed within said groove and wound along the top surface of or within said plastic layer; and a strip of RF shielding material lining said groove and disposed between the inner surface of the metal layer and the antenna windings, said strip of RF shielding material overlying the antenna windings and limited to a length and a width sufficient to track the underlying antenna windings to form an RF shield between the antenna windings and the metal layer.
2. The metal smart card of claim 1, wherein the antenna windings are wound adjacent to an outer periphery of the plastic layer.

In FIG. 1A, the subassembly 36a includes a metal substrate 361 and a plastic chip carrier layer 18. The metal layer 361 is shown with a ferrite shield 33 attached to the groove 32 and with a booster card antenna 24 formed (wound) directly within the ferrite shielded groove.

Alternatively, the coils of a booster antenna may be formed on, or within, a plastic layer. Ferrite material is formed or placed substantially only over the coil layout area to provide an RF shield and a metal layer can then be attached over the shielded coils to form a smart metal card with a limited amount of ferrite material.

FIG. 1B is a simplified partial cross-sectional view of a dual interface smart card 30. The contact pad 20c is on the same side/surface as the exterior (outer) surface of the metal layer 30. The card antenna 124 is shielded with a ferrite layer.

The ferrite may be applied as a die cut sheet or as a ferrite slurry which will harden under UV exposure or after the solvent is driven off. Substrate 30 is formed with a through bore 30a, which is shaped to receive an RFID module 20, which contains a microprocessor chip 20a, an antenna 20b and a contact pad 20c. Pad 20c is a conventional contact pad used in contact-type smart cards and is positioned to engage contacts in a card reader when the smart card is inserted therein. Antenna 20b is shown to project below metal substrate 30, for example, by about 0.01 inch.

Formed below substrate 30 is a plastic layer 134 having an antenna 124 formed by winding the coils (windings) 24a within a plastic layer 134. Layer 134 is formed with a recess shaped to receive the portion of antenna 20b that extends below substrate 30. This permits antenna 20b to extend in close proximity to antenna 124.

Preferably, the ferrite shield 33 extends laterally beyond winding 124 by at least 0.005 inches, in order to ensure that substrate 30 will not interfere with transmission or reception by antenna 124.

As shown in FIG. 1C, a metal-containing card body may include the following structure:

A metal layer 30 is intended to serve as the top layer of a card. The metal layer 30 has a top (front) surface 301 and a bottom (back) surface 302 and a thickness (D) which may range from less than 0.01 inches to more than 0.02 inches.

A plug 434 of any material which does not interfere with RF transmission is formed or shaped to conform to the dimensions of the hole/opening to fill the cut out region. Plug 434 is processed and functions to secure the IC module. The interior walls of the hole and/or the exterior walls of the plug 434 is/are coated with a suitable adhesive so the plug 434 adheres firmly to the walls of the hole/opening throughout the processing of the metal layer in the formation of the card. The plug 434 may be made of any thermoplastic material such as PET, PVC or other polymer or any material such as epoxy resins and a ceramic.

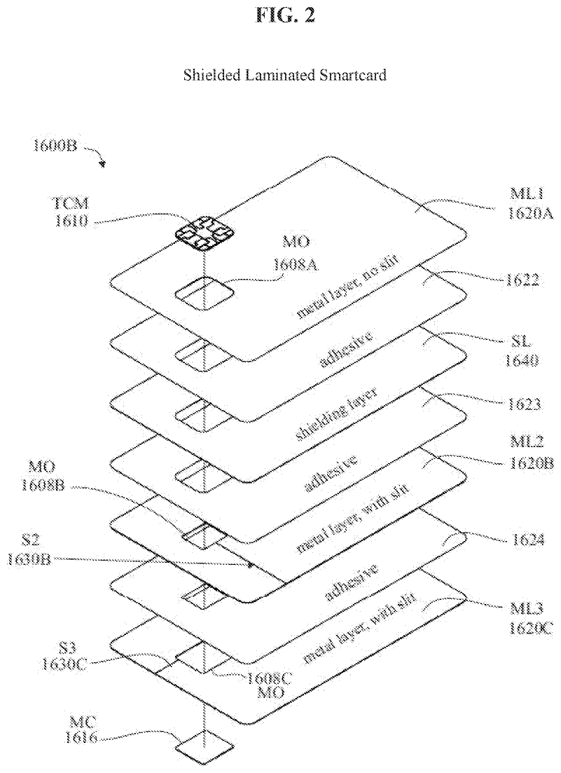

An adhesive layer 42 is used to attach a ferrite layer 44 to the back surface 302 of layer 30. An adhesive layer 46 is used to attach a plastic (e.g., PVC) layer 48 which contains and/or on which is mounted a booster antenna 47 to the ferrite layer. Layers 42, 44, 46, and 48 and the booster antenna 47 are formed in a similar manner as the corresponding number components shown in FIG. 2 and serve the same or similar functions. The assembly comprising layers 30, 42, 44, 46 and 48 is laminated to form a card assembly.

A layer 52, which includes a signature panel and a magnetic stripe, may be attached to layer 48 before or after lamination.

IC module 7 which includes a chip 7a and a chip antenna 7b and a set of contacts 7c is positioned within hole/opening and is glued in place. Physical connections extend between the booster antenna 47 and the chip antenna 7b.

Unlike other designs known in the art, a deliberately large gap between the chip and the sides of the opening is not required to provide suitable RF functionality.

As outlined in U.S. Pat. No. 10,289,944, the plug provides support for the IC module and a degree of electrical insulation and isolation from the metal layer.

Shielded Laminated Smartcard

FIG. 2 shows a shielded, laminated metal laminated shielded card (SC) 1600B having two coupling frame metal layers and a front face (ML1) which is a continuous metal layer (no slit). Some of the metal layers are the same (or similar) to those shown in the construction of FIG. 16A of U.S. Pat. No. 10,193,211.

Notably different, however, is that the top metal layer (ML1) does not have a slit (there is no “S1” in this embodiment). The second metal layer (ML2) has a slit (S2), and the third metal layer (ML3) has a slit (S3), as in the construction of FIG. 16A of U.S. Pat. No. 10,193,211, and the various layers may be held together (laminated) with layers of adhesive, as shown. The dimensions of the various layers may be similar to those in the construction of FIG. 16A of U.S. Pat. No. 10,193,211.

The front face (ML1) 1620A, as shown, does not have a slit, and may interact with the reader electromagnetic field and produce induced eddy currents within its body. These eddy currents will normally produce a counter-field resulting in reduction or blocking of the communication between the transponder chip module and reader. To offset this, a shielding layer (SL) 1640 of suitably chosen magnetic material may be placed between the front continuous metal layer and the coupling frame layers (ML2, ML3) of the card. A layer of adhesive 1622 having a thickness of 20 μm may be disposed between the front metal layer ML1 and the shielding layer SL. A layer of adhesive 1623 having a thickness of 20 μm may be disposed between the shielding layer SL and the second metal layer ML2.

The front metal layer (ML1) may have a thickness of 200 μm, rather than 300 μm (or 320 μm) as in the construction of FIG. 16A of U.S. Pat. No. 10,193,211. The shielding layer (SL) may have a thickness of approximately 50-200 μm, such as 100 μm (which was gained by making the front layer thinner than in the construction of FIG. 16A). In this manner the coupling frames will be shielded from the attenuating front metal layer and continue to function in conjunction with the transponder chip module (TCM).

Other elements of the FIG. 2 embodiment, such as the second metal layer ML2 and third metal layer ML3 may be substantially similar or identical to corresponding (similarly numbered) elements in the embodiment of FIG. 16A of U.S. Pat. No. 10,193,211. Generally, the top metal layer ML1 of FIG. 16A of U.S. Pat. No. 10,193,211 is replaced by a metal layer ML1 without a slit and a shielding layer SL.

The module antenna (MA) of the transponder chip module (TCM) may reside in a plane that lies below the continuous front metal layer (ML1). The module antenna (MA) may be surrounded on all edges (sides) by magnetic shielding material (not shown) to reduce the attenuation from eddy currents in the front metal layer (ML1). In this manner the performance of the magnetic shielding material may be maximized and the coupling of the transponder chip module (TCM) with the coupling frame layers (ML2, ML3) may be improved.

The prior art is silent on the retention of the metal sound with the card body comprising of material (several adhesive layers and a magnetic shielding layer) which dampens the drop acoustics of the metal card.

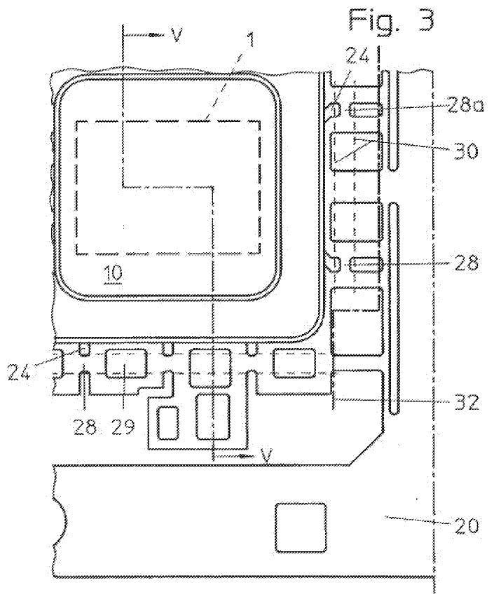

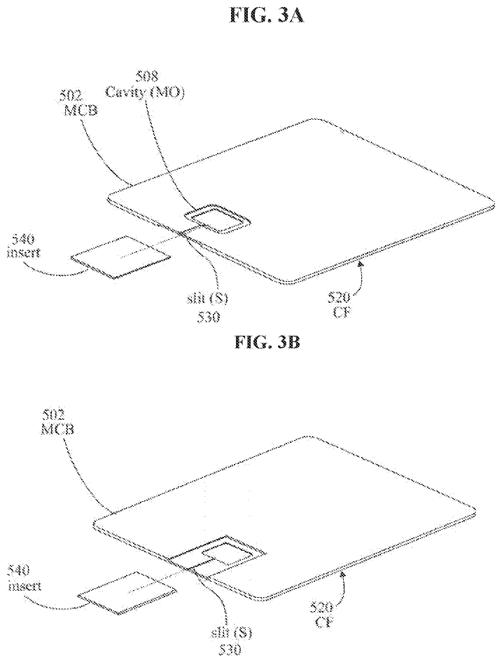

FIGS. 3A, 3B are two views (front and back) of a metal card body (MCB) 502 having a cavity (MO) 508 which is an opening for the transponder chip module (not shown) and a slit (S) 530 extending from the cavity to an outer edge of the metal card body. A reinforcing insert 540 is shown inserted into the card body at the position of the slit S.

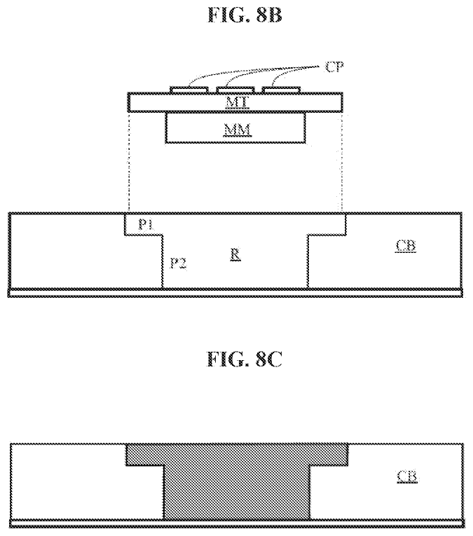

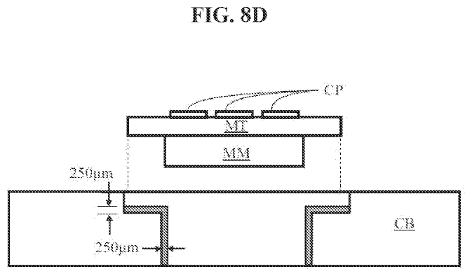

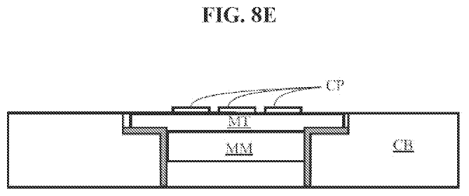

Reference may be made to FIG. 8 of US 2015/0021403 (22 Jan. 2015; Finn et al.; U.S. Pat. No. 9,798,968) which shows a metal smart card (SC) 800 comprising a full metal card body (CB) 802 with an opening (MO) 808 for a transponder chip module (TCM, not shown) and a slit (S) 830 extending from the opening (MO) to a periphery of the card body (CB) to allow the flux lines to propagate around the area of the transponder chip module (TCM). The full metal card body (CB) may be formed of an electrically conductive material, such as titanium, may have a thickness of 760 μm and may act as a coupling frame (CF) for inductive coupling with a contactless reader or point of sale terminal. The card body (CB) may comprise conductive nanoparticles.

To reinforce the card body (CB) (or metal layer (ML)) having a slit (S), a reinforcing insert (or structure or plate), of a non-conductive material such as plastic or reinforced plastic, may be disposed at (including around and covering) the location (area) of the slit (S) in a recess (R, not shown) on the underside of the card body (CB), and may extend beyond the slit. For example, the slit (S) may be 50 μm wide, the reinforcing structure may be up to or more than 8000 μm wide (approximately the size of a side of the TCM). The reinforcing structure (RS) may have a logo or design. The thickness of the reinforcing structure (and corresponding depth of the recess R on the underside of the card body CB) may be 350 μm. The opening (MO) may extend completely through the card body (CB) and the transponder chip module (TCM) may extend through the opening (MO) to the underside of the card body (CB) to allow the propagation of the electromagnetic flux lines.

FIG. 3C shows the finished shape of an intermediate product and its casing 10. Injection molding has filled with plastic material all the slits 23 and 24 as far as the webs 28, including all perforations 31. The plastic material finishes everywhere flush with the outer face of the system support 20 which was supported on the bottom half 40 of the mold. The plastic material for the casing 10 should preferably be a duroplastic synthetic resin having a low coefficient of thermal expansion, such as is generally known and used for embedding silicon chips, i.e. so-called low-stress material which contains a large proportion of quartz. By contrast, the metal used for the system support 20 has a high coefficient of thermal expansion, and therefore expands in the mold because of the temperature of the injected plastic. Later, as the metal cools, it shrinks again and encloses the plastic that fills the perforations 31 as it hardens, and thus produces a very strong compression fit of high density. This results in a mechanically stable bond between the metal parts and the resin of the casing, yet does not require the plastic resin to spread beyond the metal parts during injection molding, nor the metal to be deformed or machined in its thickness. Once the plastic casing 10 is formed, as shown in FIG. 3 of U.S. Pat. No. 5,550,402, the intermediate product taken from the mold is then further processed.

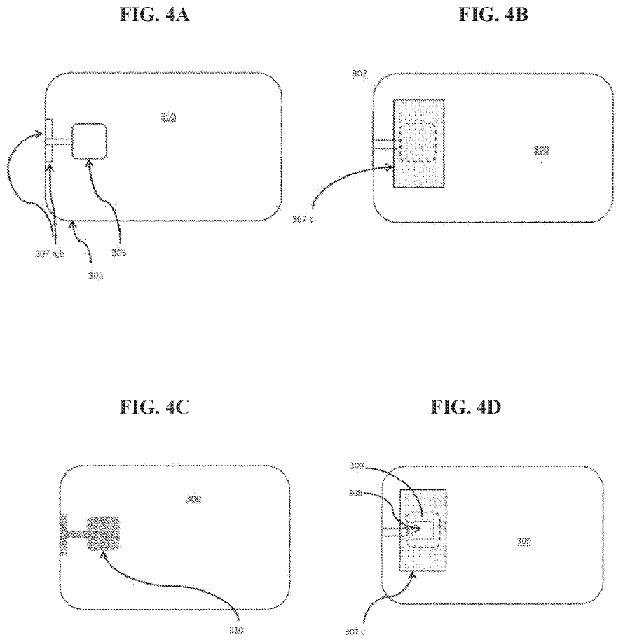

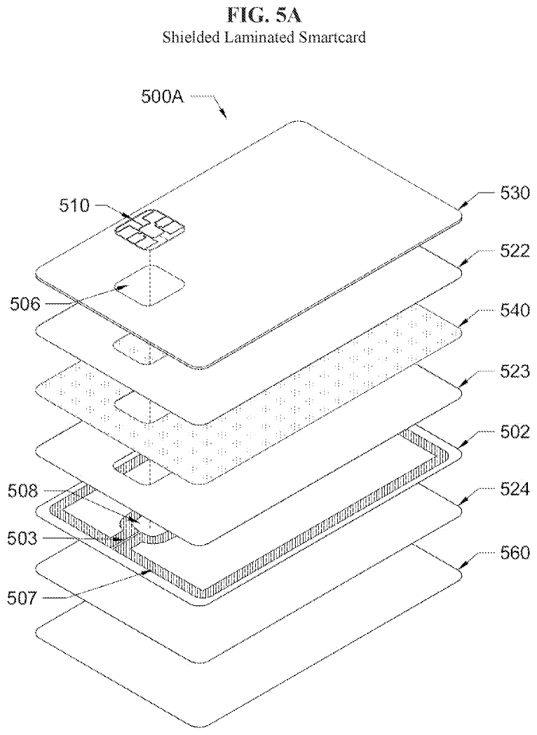

FIGS. 4A-4D show selected steps of an insert molding process for manufacturing a transaction card are depicted. In the figures, areas 305 and 308 in FIGS. 4A-4D represent holes through the cards. Area 307a,b in FIG. 4A and area 307c in FIGS. 4B and 4D represent partially covered holes (pockets) in the card body for the molding material to bind and find purchase. FIG. 4B depicts the completed molded card in which the insert molded material of molded component 310 is visible.

Although the insert molded material is shown contrasting with the background card materials for purposes of illustration, the molded component is not limited to any particular degree of contrast in coloration or shading relative to the background card, and may comprise the same materials as the front of the card or may comprise materials selected to have a coloration or shading selected to match the coloration or shading of the front, side of the card so as to minimize its visibility in a completed card. For example, in a card body comprising materials different than the molding materials (e.g. a metal or ceramic body and thermoplastic resin molding materials), the coloration of the molding materials may be selected have a color and tone that matches as closely as possible the material of the body, including using constituents in the molding materials that are the same or similar to the card body materials (e.g. inclusion of a powdered metal in the molding materials that is the same as the metal of the body). Molding materials that contrast with the body of the card may be used. FIG. 4A depicts the front side of a transaction card 300 including an opening 305 which extends entirely through a card body 302. A plurality of securing features 307a, b provide areas to which the molding material can adhere or otherwise bind. In the depicted illustration, securing features 307a,b are blind holes (e.g., pockets). A similar set of securing features 307c are found on the opposing rear side of transaction card 300 in FIG. 4B. The geometries of opening 305 and securing features 307a, b, c were selected to improve the RF performance of the metal transaction card 300. Securing features 307a, b, c may comprise a material that is the same or otherwise compatible with the molding material, and different than the card body material, such that the molding material and the materials of the securing features melt or otherwise join together with a bond that is relatively stronger than any bond created between the molding material and the card body.

FIG. 4C depicts the front side of the transaction card 300 after an insert molded electronic component 310 has been placed into opening 305. In the depicted illustration, molded electronic component 310 would be visible on transaction card 300. The geometry of molded electronic component 310 permits molded electronic component 310 to become secured to transaction card 300 through a biasing action created by securing features 307a,b,c. Alternatively, or additionally, molded electronic component 310 may be adhered to opening 305 of transaction card 300 using an epoxy resin such as Bisphenol, Novolac, Aliphatic, and Glycidylamine.

Excess molding material may be removed from molded electronic component 310 (by, e.g., milling or machining) to incorporate additional electronic components or other desired components.

Shielded Metal Laminated Transaction Card with Coupling Frame Antenna

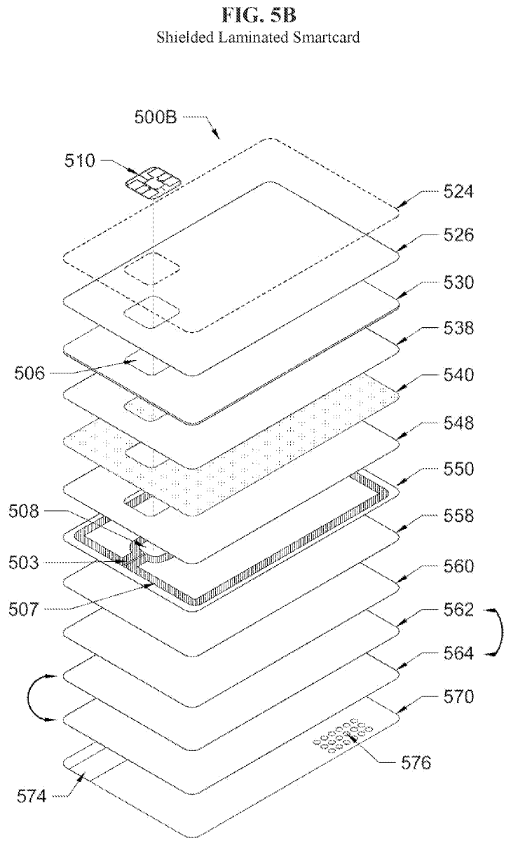

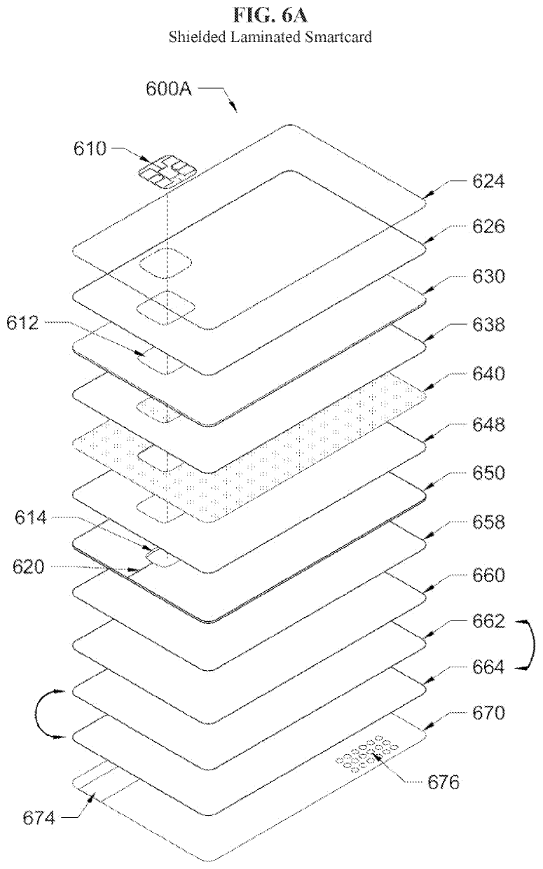

FIG. 5A shows the following exemplary stack-up of layers for a card 500A, from a front surface (side) of the card to a rear surface (side) of the card:
a front metal layer (ML) 530 having a module opening 506, and no slit (“continuous”) compare “530” in FIG. 5B
an adhesive layer 522 (also having a module opening)
a shielding layer (SL) 540 (also having a module opening)
an adhesive layer 523 (also having a module opening)
a support layer 502 having a module opening 508
a coupling frame antenna (“CFA”) 507 formed on the support layer 502, the coupling frame antenna having a slit portion 503 and a portion surrounding the module opening 508
an adhesive layer 524 (optionally having a module opening)
a rear plastic layer (PL) 560 (no module opening)

A dual-interface transponder chip module (TCM) 510 may be inserted into the module openings in the various layers of the card 500A.

FIG. 5A is a diagrammatic view of a shielded metal laminated transaction card 500A, generally comprising (from top-to-bottom, as viewed): a 6 or 8 pin (contact pad) dual interface transponder chip module (TCM) 510, a top (front) metal layer (ML) 530 which may have a thickness of approximately 300 or 400 μm. Notably different to the prior art, however, is that the top metal layer (ML) does not have a slit. The continuous front metal layer may comprise titanium, aluminum, brass or stainless steel.

The front face metal layer 530, as shown, does not have a slit, and may interact with an electromagnetic field produced by an external reader (such as a POS terminal) to produce induced eddy currents within its metal body. These eddy currents will normally produce a counter-field resulting in reduction or blocking of the communication between the dual interface transponder chip module and the reader.

To offset the counter-field, a shielding layer (SL) 540 of magnetic material, such as ferrite, on an insulating layer may be disposed between the front metal layer 530 and a coupling frame antenna (CFA) which is disposed on a supporting substrate 502.

A layer of adhesive 522 having a thickness of 20 μm may be disposed between the front metal layer (ML) and the shielding layer (SL). A layer of adhesive 523 having a thickness of 20 μm may be disposed between the shielding layer (SL) and the bottom coupling frame antenna (CFA) on the supporting substrate 502. A slit (S) 503 is shown extending from the left edge of the coupling frame antenna (CFA) to an opening (MO) 508 for the dual interface transponder chip module (TCM) 510. Optionally, a capacitor may be connected across the slit portion of the coupling frame antenna (CFA).

The coupling frame antenna (CFA) on the supporting substrate may not have an opening MO, but rather may simply have a portion encircling a position defined for the dual interface transponder chip module. The coupling frame antenna (CFA) is shown having a portion defining a slit (S) extending from a periphery of the card to the position of the transponder chip module to overlap and couple with the module antenna (aka a micro-antenna) of the transponder chip module. See, for example, U.S. Pat. No. 10,552,722, incorporated by reference herein, which discloses:
FIG. 2 of U.S. Pat. No. 10,552,722 is a diagram of an exemplary coupling frame antenna (CFA) with a track width of approximately 3 mm. The design shown illustrates a continuous closed loop single track coupling frame antenna (CFA) 202 placed within the perimeter defined by the card body (CB) 201. It is noted that the figure is illustrative of the shape and overall form of the coupling frame antenna (CFA) 202 and that the antenna may reside upon or between any of the layers that may make up a typical smartcard. The outer edges of the coupling frame antenna (CFA) 402 may extend to the periphery of the card body (CB) 201 or be offset from the edge of the smartcard by some distance to aid lamination or other assembly of the smartcard's additional layers. The path defined by the coupling frame antenna (CFA) 201 extends inwards towards and around the module opening (MO) 204. The length, width and track thickness of the coupling frame antenna (CFA) 202 in the vicinity of the module opening (MO) 204 may be set as to provide an optimum overlap with the module antenna (MA) of the transponder chip module (TCM).
The shape of the coupling frame antenna, as it extends inwardly from the left (as viewed) side of the card body to the module opening area, results in two side-by-side portions of the coupling frame antenna (CFA) being closely adjacent each other, with a gap therebetween. This gap may be comparable to the slit (S) in a conventional coupling frame (CF).

With the construction shown in FIG. 5A, the coupling frame antenna will be shielded from the RF-attenuating front metal layer (ML) and continue to function in conjunction with the dual interface transponder chip module (TCM).

The module antenna (MA) of the transponder chip module may be substantially surrounded (on all sides) by magnetic shielding material (not shown) to reduce attenuation from eddy currents in the front metal layer (ML).

In this manner, the performance of the magnetic shielding material (540) may be maximized and the coupling of the dual interface transponder chip module (TCM) 510 with the coupling frame antenna (CFA) 502 may be improved.

The rear plastic layer (PL) 560 capturing (supporting) a magnetic stripe and security elements (not shown) of the transaction card may be attached to the supporting substrate 502 for the CFA by means of the adhesive layer 524.

The coupling frame antenna (CFA) may alternatively reside in (be disposed upon) the rear plastic layer (PL). The module antenna (MA) of the dual interface transponder chip module (TCM) may reside in a plane that lies below the front metal layer (ML).

The module antenna (MA) may be physically connected to the coupling frame antenna (forming a series or parallel RLC circuit). The coupling frame antenna may be connected via connection tracks or wire bonds to the antenna pads Lₐ and L_{b} of the dual interface transponder chip.

A second coupling frame antenna (not shown) having a slit or gap extending from an outer edge of the coupling frame antenna (CFA) to an inner position thereof may be provided wherein the slit or gap is disposed to overlap at least a portion of the module antenna, and a dielectric layer may be disposed between the two coupling frame antennas. The two coupling frame antennas can be stacked, one atop the other, with a dielectric therebetween, in the manner of the metal interlayers (650) discussed below.

FIG. 5B is a diagram of the stack-up construction of a dual interface metal face smartcard 500B with contactless tap to pay function on one side of the card body, generally comprising (from top-to-bottom, as viewed):

The stack-up construction of the card body 500B (smartcard (SC) or transaction card (TC)) with a front face continuous metal layer without a discontinuity may comprise the following layers:

CFA: Coupling frame antenna (CFA) 507 formed on a support layer 550, the coupling frame antenna having a slit portion 503 and a portion surrounding the module opening 508

510: Transponder chip module (TCM) or inductive coupling chip module (ICM);

524: Protective hard coat layer (5-10 μm)—a lamination hard top-coat film or a printed coating (ink, varnish or a polymer) which can be laser marked or laser engraved;

526: A print layer which may compose of: (i) a digital, silk screen, lithographic or thermo-graphic layer of clear or colored ink, (ii) a baked-on-ink layer, (iii) a PVD or DLC coating, or (iv) a combination thereof, including an adhesion promoter or primer applied between the metal layer 530 and subsequent coatings;

530: Front face metal layer with a module opening (MO) 606 and without a slit (“continuous”, no slit) which may have a print layer 526, typically having a thickness of 150 μm;

538: Adhesive layer (25 μm)—thermosetting epoxy—to attach the ferrite layer 540 to the rear side of the front face metal layer 530;

540: High permeability magnetic sheet shielding layer with a thickness of 50 μm or 100 μm which may compose of the following: calcium carbonate (CaCO₃), silicon dioxide (SiO₂), magnesium fluoride (MgF₂), SiO2, chromium (Cr) and iron (Fe), to offset the effects of electromagnetic shielding caused by the front face metal layer 530; the shielding layer may comprise ferrite particles in a binder or on a support layer

548: Adhesive layer (25 μm)—thermosetting epoxy—spanning the entire width and length of the card body, being assembled to the rear side of the front face metal layer 530 and to the ferrite layer 540;

550: Support layer for the coupling frame antenna 503;

558: Adhesive layer (25 μm)—thermosetting epoxy—spanning the entire width and length of the card body;

560: Transparent, translucent or white synthetic layer (e.g. PVC, PC, PETG), typically 150 μm;

562 primer;

564 ink (printed information (PI)); The position of 562 and 564 may be interchangeable depending on the printing process.

570: Laser engravable overlay layer (PVC), typically 64 μm;

574: Magnetic stripe;

576: Operation of laser marking the rear overlay layer with personalization data;

Security elements (signature panel and hologram are not shown.

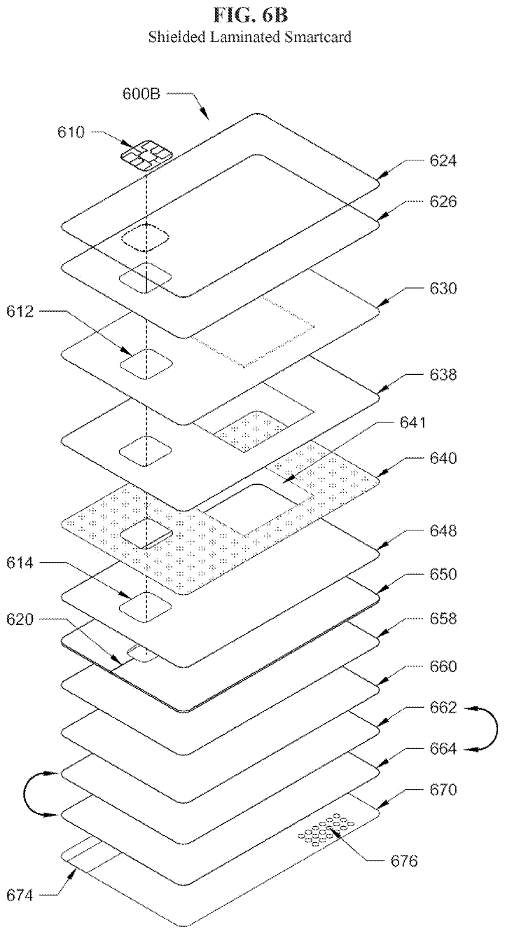

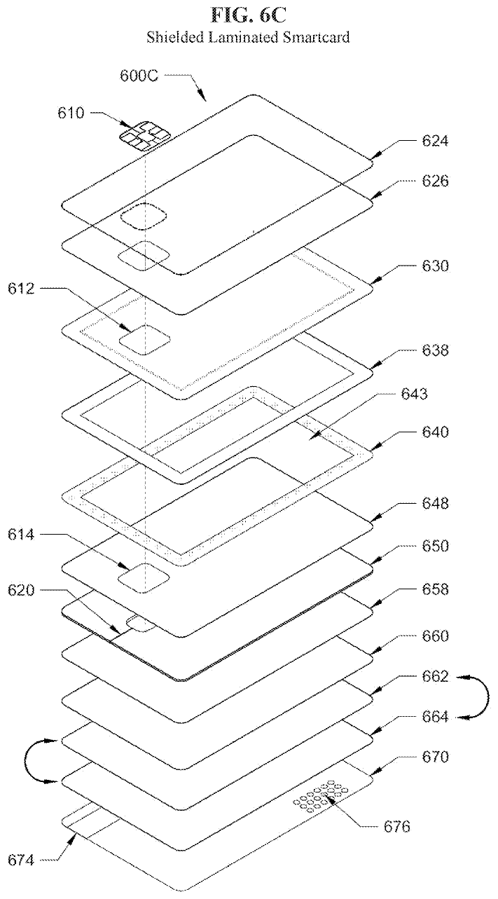

FIG. 6A is a diagram of the stack-up construction of a dual interface metal face smartcard 600A with contactless tap to pay function on one side of the card body, having a front face solid metal layer 630 without a discontinuity attached to underlying layers by means of an adhesive system which does not dampen the inherent metal sound of the card body. The metal interlayer 650 has a slit (S), a module opening (MO) 614 to accept the insertion of a transponder chip module 610 for inductive coupling.

The stack-up construction of the card body (CB) 600A (smartcard (SC) or transaction card (TC)) with a front face continuous metal layer without a discontinuity may comprise the following layers:

610: dual-interface Transponder Chip Module (TCM) or inductive coupling module (ICM);

612: P1 Module opening (MO);

614: P2 Module opening (MO);

620: Slit (S) in the metal interlayer acting as a coupling frame for contactless communication;

676: Operation of laser marking the rear overlay layer with personalization data;

624: Protective hard top-coat layer (5-10 μm)—a hard top-coat lamination film or a deposited coating (ink, varnish or a polymer) which can be laser marked or laser engraved;

626: A print layer (25 μm) which may compose of: (i) a digital, silk screen, lithographic or thermo-graphic layer of clear or colored ink (ii) a baked-on-ink layer, (iii) a PVD or DLC coating, or (iv) a combination thereof, including an adhesion promoter or primer applied between the metal layer 630 and subsequent coatings;

630: Front face metal layer with a module opening 612 and without a slit (“continuous”) which may have a print layer 626, typically the metal layer having a thickness of 150 μm;

638: Adhesive layer (25 μm)—thermosetting epoxy—to attach the ferrite layer 640 to the rear side of the front face metal layer 630;

640: High permeability magnetic sheet shielding layer with a thickness of 50 μm or 100 μm which may compose of the following: calcium carbonate (CaCO₃), silicon dioxide (SiO₂), magnesium fluoride (MgF₂), SiO2, chromium (Cr) and iron (Fe), to offset the effects of electromagnetic shielding caused by the front face metal layer 630;

648: Adhesive layer (25 μm)—thermosetting epoxy—to attach the ferrite layer 640 to the front side of the metal interlayer 650 with slit 620;

650: Metal interlayer or layers with a slit 620 (300-350 μm);

This is comparable to the CFA's shown in FIGS. 5A,B

If there are two metal layers with slits, they may be separated by a dielectric or insulating layer, such as adhesive.

658: Adhesive layer (25 μm)—thermosetting epoxy—to attach the metal interlayer 650 to the front side of the synthetic layer 660;

660: Transparent, translucent or white synthetic layer (e.g. PVC, PC, PETG), typically having a thickness of 150 μm;

662 primer;

664 ink (printed information (PI));

The positions of 662 and 664 may be interchangeable depending on the printing process.

670: Laser engravable overlay layer (PVC), typically having a thickness of 64 μm;

674: Magnetic stripe;

Security elements (signature panel and hologram are not shown.

FIG. 6B is a modified diagram of FIG. 6A showing a stack-up construction of a dual interface metal face smartcard 600B with contactless tap to pay function on one side of the card body, having a front face solid metal layer 630 without a discontinuity with its rear surface having a protruding metal section (a boss) 632, which may be off-center. The metal interlayer 650 has a slit (S), a module opening (MO) 614 to accept the insertion of a transponder chip module 610 for inductive coupling.

The boss 632 is a portion of the metal layer 630 that is deformed to protrude downward from the metal layer 630, and fit snugly into a corresponding hole 641 in the underlying ferrite layer 640. This helps protect the card body against delamination. Contrast this with FIGS. 1A,B having ferrite 32 protruding up into the metal 30 above. This feature (the metal layer protruding down into the underlying shielding layer) may be applied to other embodiments shown herein, whether or not explicitly shown and described.

The stack-up construction of the card body (CB) 600B (smartcard (SC) or transaction card (TC)) with a front face continuous metal layer without a discontinuity may comprise the following layers:

610: Transponder chip module (TCM) or inductive coupling chip module (ICM);

612: P1 Module opening (MO);

614: P2 Module opening (MO);

620: Slit (S) in the metal interlayer acting as a coupling frame for contactless communication;

676: Operation of laser marking the rear overlay layer with personalization data;

624: Protective hard top-coat layer (5-10 μm)—a hard top-coat lamination film or a deposited coating (ink, varnish or a polymer) which can be laser marked or laser engraved;

626: A print layer (25 μm) which may compose of: (i) a digital, silk screen, lithographic or thermo-graphic layer of clear or colored ink, (ii) a baked-on-ink layer, (iii) a PVD or DLC coating, or (iv) a combination thereof, including an adhesion promoter or primer applied between the metal layer 630 and subsequent coatings;

630: Front face metal layer without a slit which may have a print layer 626, typically the metal layer having a thickness of 150 μm—with its rear surface having an off-center protruding metal section (a boss) 632 (e.g. 25 mm×30 mm) having a stepped ledge 636 having a height equal to the thickness of the underlying adhesive layer 638 and the ferrite layer 640, approximately 75 μm or 125 μm;

638: Adhesive layer (25 μm)—thermosetting epoxy—to attach the ferrite layer 640 to the rear side of the front face metal layer 630 having an opening for the protruding metal section 632;

640: High permeability magnetic sheet layer with a thickness of 50 μm or 100 μm which may compose of the following: calcium carbonate (CaCO₃), silicon dioxide (SiO₂), magnesium fluoride (MgF₂), SiO2, chromium (Cr) and iron (Fe), to offset the effects of electromagnetic shielding caused by the front face metal layer 630;

648: Adhesive layer (25 μm)—thermosetting epoxy—spanning the entire width and length of the card body, being assembled to the protruding metal section (a boss) 632 on the rear side of the front face metal layer 630 and to the ferrite layer 640 which is flush with the outer surface of the protruding metal section (a boss) 632;

650: Metal interlayer or layers with a slit 620 (300-350 μm); a metal layer with a module opening (MO) and a slit (S) may be referred to as a coupling frame (CF)

658: Adhesive layer (25 μm)—thermosetting epoxy—to attach the metal interlayer 650 to the front side of the synthetic layer 660;

660: Transparent, translucent or white synthetic layer (e.g. PVC, PC, PETG), typically having a thickness of 150 μm;

662 primer;

664 ink (printed information (PI));

The position of 662 and 664 may be interchangeable depending on the printing process.

670: Laser engravable overlay layer (PVC), typically having a thickness of 64 μm;

674: Magnetic stripe;

Security elements (signature panel and hologram are not shown.

So, in FIG. 6B, there is a continuous metal layer 630 with an opening 612 and without a slit, under which is a ferrite shielding layer 640, under which is a discontinuous metal layer (or frame) 650 with slit and opening.

FIG. 6C is a modified diagram of FIG. 6B showing a stack-up construction of a dual interface metal face smartcard 600C with contactless tap to pay function on one side of the card body, having a front face solid metal layer 630 without a discontinuity with its rear surface having a protruding metal layer 633 which fits into a frame comprising of anti-shielding material. The metal interlayer 650 has a slit (S), a module opening (MO) 614 to accept the insertion of a transponder chip module 610 for inductive coupling.

The stack-up construction of the card body (CB) 600C (smartcard (SC) or transaction card (TC)) with a front face continuous metal layer without a discontinuity may comprise the following layers:

610: Transponder chip module (TCM) or inductive coupling chip module (ICM);

612: P1 Module opening (MO);

614: P2 Module opening (MO);

620: Slit (S) in the metal interlayer acting as a coupling frame for contactless communication;

676: Operation of laser marking the rear overlay layer with personalization data;

624: Protective hard top-coat layer (5-10 μm)—a hard top-coat lamination film or a deposited coating (ink, varnish or a polymer) which can be laser marked or laser engraved;

626: A print layer (25 μm) which may compose of: (i) a digital, silk screen, lithographic or thermo-graphic layer of clear or colored ink, (ii) a baked-on-ink layer, (iii) a PVD or DLC coating, or (iv) a combination thereof, including an adhesion promoter or primer applied between the metal layer 630 and subsequent coatings;

630: Front face metal layer without a slit which may have a print layer 626, typically the metal layer having a thickness of 150 μm—with its rear surface having a protruding metal layer 633 having a stepped ledge 637 having a height equal to the thickness of the underlying adhesive frame layer 638 and the ferrite frame layer 640, approximately 75 μm or 125 μm;

638: Adhesive frame layer (25 μm)—thermosetting epoxy—to attach the ferrite frame layer 640 to the rear side of the front face metal layer 630 having an opening for the protruding metal layer 633;

640: High permeability magnetic sheet layer with a thickness of 50 μm or 100 μm made of polymer magnetic sheet technology to offset the electromagnetic attenuation caused by the front face metal layer 630; This ferrite layer 640 has an oversize hole 643 (compare 641, FIG. 6B) for receiving the protrusion from the overlying metal layer 630. The hole is very large, such as 35 mm by 65 mm or smaller, resulting in a band (or ring) of ferrite material, approximately 10 mm wide, being disposed around the periphery of the underlying supporting layer. (The ID-1 spec for the size of the card is approximately 86 mm×54 mm)

648: Adhesive layer (25 μm)—thermosetting epoxy—spanning the entire width and length of the card body, being assembled to the protruding metal layer 633 on the rear side of the front face metal layer 630 and to the ferrite frame layer 640 which is flush with the outer surface of the protruding metal layer 633;

650: Metal interlayer or layers with a slit 620 (300-350 μm); a metal layer with a module opening (MO) and a slit (S) may be referred to as a coupling frame (CF)

658: Adhesive layer (25 μm)—thermosetting epoxy—to attach the metal interlayer 650 to the front side of the synthetic layer 660;

660: Transparent, translucent or white synthetic layer (e.g. PVC, PC, PETG), typically having a thickness of 150 μm;

662 primer;

664 ink (printed information (PI));

The position of 662 and 664 may be interchangeable depending on the printing process.

670: Laser engravable overlay layer (PVC), typically having a thickness of 64 μm;

674: Magnetic stripe;

Security elements (signature panel and hologram are not shown.

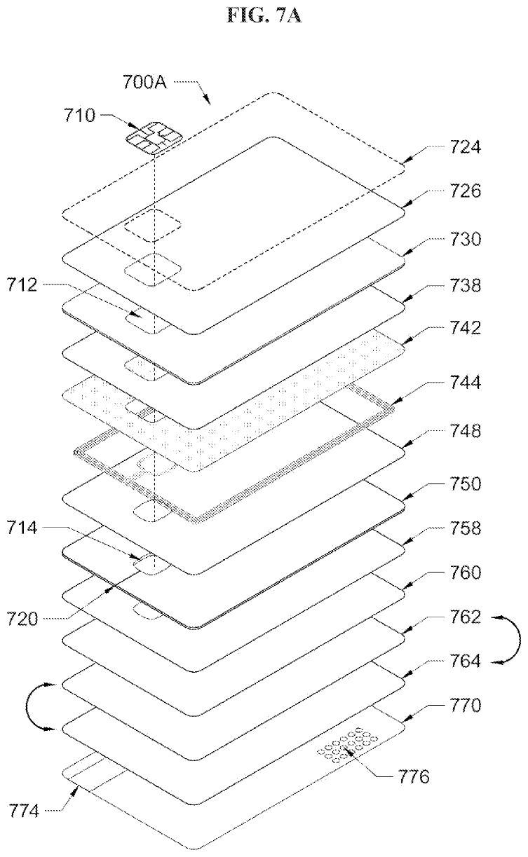

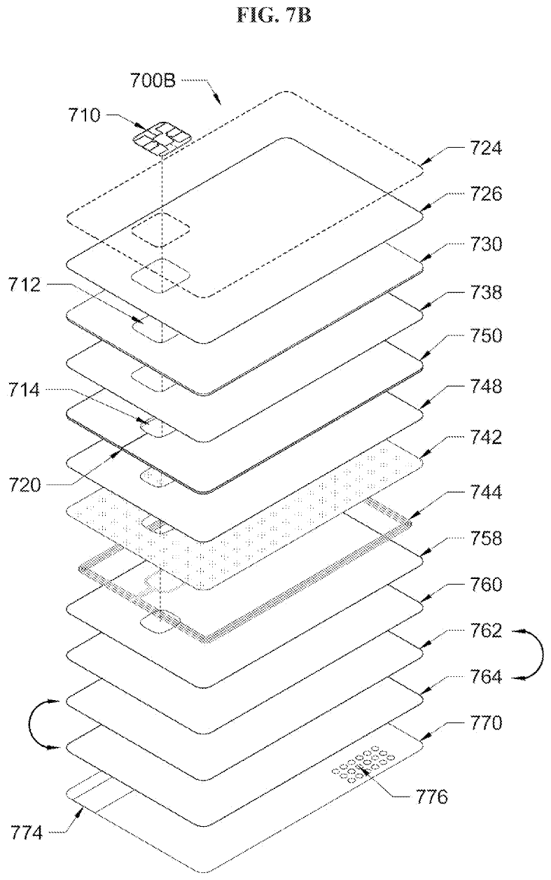

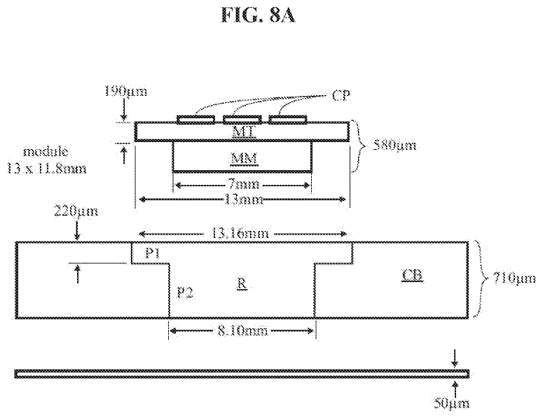

FIG. 7A is a diagram (exploded perspective view) of the stack-up construction of a dual interface metal face smartcard 700A with contactless tap to pay function on one side of the card body having a booster antenna circuit 744 mounted on a magnetic shielding layer 742 in combination with a metal interlayer 750 having a slit to function as a coupling frame. The front face solid metal layer 730 is continuous metal layer with no discontinuity. The metal interlayer 750 has a slit (S) 720, a module opening (MO) 714 to accept the insertion of a transponder chip module 710 with its module antenna inductively coupling with the coupler coil of the booster antenna 744 and the slit 720 in the metal interlayer 750. The metal interlayer 750 with slit may be replaced by a coupling frame antenna (CFA).

The stack-up construction of the card body (CB) 700A (smartcard (SC) or transaction card (TC)) with a front face continuous metal layer without a discontinuity may comprise the following layers (all dimensions are exemplary and approximate):

710: dual-interface Transponder Chip Module (TCM) or inductive coupling module (ICM);

712: P1 Module opening (MO), in front face metal layer (ML1) 730 without a slit

714: P2 Module opening (MO), in metal interlayer or layers 750 with a slit 720

720: Slit (S) in the metal interlayer 750 acting as a coupling frame for contactless communication;

776: Operation of laser marking the rear overlay layer 770 with personalization data;

compare 576 in FIG. 5B, and 676 in FIGS. 6A,B,C

724: Protective hard coat layer (5-10 μm)—a hard top-coat lamination film or a deposited coating (ink, varnish or a polymer) which can be laser marked or laser engraved;

726: A print layer (25 μm) which may comprise: (i) a digital, silk screen, lithographic or thermo-graphically layer of clear or colored ink, (ii) a baked-on-ink layer, (iii) a PVD or DLC coating, or (iv) a combination thereof, including an adhesion promoter or primer applied between the metal layer 730 and subsequent coatings;

730: Front face metal layer without a slit (“continuous”), which may have the print layer 726 disposed on it. A typical thickness for this metal layer may be 150 μm;

738: Adhesive layer (25 μm)—thermosetting epoxy—to attach the ferrite layer 742 with booster antenna circuit 744 to the rear side of the front face metal layer 730;

742: High permeability magnetic sheet shielding layer with a thickness of 50 μm or 100 μm which may compose of the following: calcium carbonate (CaCO₃), silicon dioxide (SiO₂), magnesium fluoride (MgF₂), SiO2, chromium (Cr) and iron (Fe), to offset the effects of electromagnetic shielding caused by the front face metal layer 730 and having a booster antenna circuit 744 assembled to its face downside;

744: Booster antenna circuit assembled on a high permeability, low magnetic loss ferrite layer 742 comprising of a perimeter coil, a coupler coil and a set of trimming capacitors (not shown, are very small);

The booster antenna circuit 744 is comparable to the CFA in FIGS. 5A,B, but has multiple turns (windings) and is a booster antenna (such as wire embedded, or etched). The CFA is a single turn (or winding). The booster antenna “circuit” is similar to a booster antenna as disclosed in U.S. Pat. No. 9,033,250, but has capacitors integrated into it.

748: Adhesive layer (25 μm)—thermosetting epoxy—spanning the entire width and length of the card body, being assembled to the rear side of the booster antenna circuit 744 and the metal interlayer 750 with a slit 720;

750: Metal interlayer or layers with a slit 720; The metal interlayer may be two metal layers with slits, separated by a dielectric (insulating) layer, which may be adhesive. The thickness of the metal interlayer may be 300-350 μm.

A metal layer with slit and module opening may be referred to as a “coupling frame” (CF). See, e.g., U.S. Pat. Nos. 9,475,086; 9,798,968. And, two or more coupling frames may be stacked up, for example as in U.S. Pat. No. 9,836,684, which also discussed the need for reinforcing the metal layer at the position of the slit, which may be regarded as a mechanical defect.

758: Adhesive layer (25 μm)—thermosetting epoxy—to attach the metal interlayer 750 to the front side of the synthetic layer 760;

760: Transparent, translucent or white synthetic layer (e.g. PVC, PC, PETG), typically having a thickness of 150 μm;

762 primer;

764 ink (printed information (PI));

The position of 762 and 764 may be interchangeable depending on the printing process.

770: Laser engravable overlay layer (PVC), typically having a thickness of 64 μm;

774: Magnetic stripe;

Security elements (signature panel and hologram) are not shown.

In this, and other embodiments disclosed herein, the card body may have a metal layer (or layers) which are substantially the full size of the card body, and the metal layer(s) have a module opening and may have a slit extending from a peripheral edge of the metal layer(s) to the module opening to facilitate the metal layer(s) to function as coupling frame(s) to permit contactless capability. In some embodiments, a metal layer may have a module opening and no slit.

In this, and other embodiments disclosed herein, the construction of a card body may be shown, in an “exploded” perspective view, showing the various layers of the card body from the front (top) of the card body to the rear (bottom) of the card body. The constructions may be described from front-to-back, with some layers being described as being behind other layers.

In FIG. 7A, the continuous metal layer 730 attenuates the electromagnetic field and so in order to passively power a transponder chip module by inductive coupling, shielding material 742 is required in the stack-up construction. An important aspect of the adhesive layer 738 between the metal layer 730 and the shielding layer 742 is the function as a dielectric spacer (738). The thicker the shielding layer, the greater the RF performance. The greater the distance between the metal layer 730 and the shielding layer 742, the greater is the frequency uplift of the system resonance frequency and the RF performance in terms of activation distance. The activation distance may be further enhanced by a coupling frame or discontinuous metal layer 750 positioned underneath the booster antenna circuit 744, separated by an adhesive layer 748. The coupling frame or discontinuous metal layer 750 also uplifts (raises) the system resonance frequency of the metal transaction card 700A. This (the function of the dielectric spacer) may be applicable to some of the other embodiments disclosed herein, whether or not explicitly disclosed.

Also, the slit in the discontinuous metal layer 750 can be disguised with a primer, printed ink and a protective coating (ink, varnish or a polymer). This (disguising the slit in a discontinuous metal layer) may be applicable to some of the other embodiments disclosed herein, whether or not explicitly disclosed.

Regulating the Card Body Weight while Increasing the Thickness of the Dielectric Spacer

By way of an example in FIG. 7A, the weight of a metal transaction card is primarily determined by the combined weight of the continuous metal layer 730 and the discontinuous metal layer 750. By increasing the thickness of the dielectric spacer 738 between the continuous metal layer 730 and the shielding layer 742, and or increasing the thickness of the shielding layer 742 to enhance the RF performance, it is necessary to reduce the thickness of the metal layers which reduces the card body weight or to remove the synthetic layers from the rear side of the card body while maintaining the thickness of the metal layers. By removing the synthetic layers 758 (adhesive layer 25 μm) and 760 (transparent, translucent or white plastic layer 150 μm) and replacing them with a hard top coat lamination film ˜10 μm (laser reactive) with an outer adhesive layer which can accept printed information (PI) 764 ink, with the option to attach a laser engravable overlay layer 770 (PVC) typically having a thickness of 64 μm.

In the following diagram (FIG. 7B), the metal interlayer 750 shown in FIG. 7A is relocated to be between the front face metal layer and the ferrite (shielding) layer with underlying booster antenna circuit.

FIG. 7B is a diagram (exploded perspective view) of the stack-up construction of a dual interface metal face smartcard 700B with contactless tap to pay function on one side of the card body having a top metal interlayer 750 having a slit 720 to function as a coupling frame assembled underneath the front face metal layer 730 without a slit, and further comprising of a booster antenna circuit 744 mounted on a magnetic shielding layer 742 to operate in combination with the metal interlayer 750. The front face solid metal layer 730 is continuous metal layer with no discontinuity. The front face metal layer has an opening 712, the metal interlayer 750 has a slit (S) 720 and a module opening (MO) 714 to accept the insertion of a transponder chip module 710 with its module antenna inductively coupling with the slit 720 in the coupling frame 750 as well as with the coupler coil of the booster antenna 744. The metal interlayer 750 with slit may be replaced by a coupling frame antenna. The metal interlayer 750 may also not need to inductively couple with the module antenna, but rather take on the function as a discontinuous metal frame (DMF).

The stack-up construction of the card body (CB) 700B (smartcard (SC) or transaction card (TC)) with a front face continuous metal layer without a discontinuity may comprise the following layers:

710: Transponder chip module (TCM) or inductive coupling chip module (ICM);

712: P1 Module opening (MO);

714: P2 Module opening (MO);

720: Slit (S) in the top metal interlayer 750 acting as a coupling frame for contactless communication;

776: Operation of laser marking the rear overlay layer with personalization data;

compare 676 in FIGS. 6A,B,C

724: Protective hard coat layer (5-10 μm)—a hard top-coat lamination film or a deposited coating (ink, varnish or a polymer) which can be laser marked or laser engraved;

726: A print layer (25 μm) which may comprise of: (i) a digital, silk screen, lithographic or thermo-graphic layer of clear or colored ink, (ii) a baked-on-ink layer, (iii) a PVD or DLC coating, or (iv) a combination thereof, including an adhesion promoter or primer applied between the metal layer 730 and subsequent coatings;

730: Front face metal layer without a slit (continuous) which may have a print layer 726, typically the metal layer having a thickness of 150 μm;

738: Adhesive layer (25 μm)—thermosetting epoxy—to attach the metal interlayer 750 with slit 720 to the rear side of the front face metal layer 730;

750: Metal interlayer or layers with a slit 720 (300-350 μm); Note that in FIG. 7B, the discontinuous (with slit) metal layer (coupling frame) 750 is on top of the booster antenna circuit 744, rather than below it, as in FIG. 7A.

748: Adhesive layer (25 μm)—thermosetting epoxy—spanning the entire width and length of the card body, being assembled to the rear side of the metal interlayer 750 with a slit 720 and the top side of the ferrite layer 742;

742: High permeability magnetic sheet layer with a thickness of 50 μm or 100 μm which may compose of the following: calcium carbonate (CaCO₃), silicon dioxide (SiO₂), magnesium fluoride (MgF₂), SiO2, chromium (Cr) and iron (Fe), to offset the effects of electromagnetic shielding caused by the front face metal layer 730, and having a booster antenna circuit 744 assembled to its bottom side;

744: Booster antenna circuit assembled on a high permeability, low magnetic loss ferrite layer 742 comprising of a perimeter coil, a coupler coil and a set of trimming capacitors;

758: Adhesive layer (25 μm)—thermosetting epoxy—to attach the booster antenna circuit 744 on the ferrite layer 742 to the front side of the synthetic layer 760;

760: Transparent, translucent or white synthetic layer (e.g. PVC, PC, PETG), typically having a thickness of 150 μm;

762 primer;

764 ink (printed information (PI));

The position of 762 and 764 may be interchangeable depending on the printing process.

770: Laser engravable overlay layer (PVC), typically having a thickness of 64 μm;

774: Magnetic stripe;

Security elements (signature panel and hologram) are not shown.

So, in FIG. 7B, there is a continuous metal layer 730 with an opening and without a slit, under which is a discontinuous metal layer (or frame) 750 with slit and opening, under which is a ferrite shielding layer 742, below which is the booster antenna circuit 744.

Although not shown, the discontinuous metal layer 750 (with slit) could have a portion protruding downward in the manner of the portion 632 of the layer 632 shown in FIG. 6B (and the protruding portion fits into the hole/opening 641 in the ferrite shielding layer 640 (in 7B, 742)

An Overview of the Embodiments Shown in FIGS. 5A/B, 6A/B/C, 7A/B

These figures show some examples of smartcards (or transaction cards) having ID-1 format, which are dual interface (contact and contactless).

Some of the card body constructions may have a front metal layer (e.g., 530, 630, 730) having a module opening for accepting insertion of a transponder (or inductive) chip module having contact pads on its front surface for the contact interface, and an internal module antenna for inductive coupling to facilitate the contactless interface. This front metal layer does not have a slit, and may therefore be referred to as “continuous”. Because there is no slit in the front metal layer, the front metal layer impairs contactless functionality from the front of the card, and the card may be referred to as “one-sided”, meaning that its contactless functionality works only from the back side of the card.

Some of the card body constructions may have a shielding layer (e.g., 540, 640, 742) disposed below the front metal layer. Most of the shielding layers are the same size (ID-1) as the card body.

The FIG. 5A construction has a coupling frame antenna (CFA) disposed on a support layer (502) behind the shielding layer.

The FIG. 5B construction has a coupling frame antenna (CFA) disposed on a support layer (550) behind the shielding layer.

The FIG. 6A construction has a coupling frame (metal layer 650 with a slit 620) disposed behind the shielding layer.

The FIG. 6B construction has a coupling frame (metal layer 650 with a slit 620) disposed behind the shielding layer.

The FIG. 6C construction has a coupling frame (metal layer 650 with a slit 620) disposed behind the shielding layer, which is disposed around the periphery of the card.

The shielding layer may have a hole 641 (FIG. 6B) or an oversize hole 643 (FIG. 6C) for accepting a protrusion from the overlying continuous metal layer.

The FIG. 7A construction has a booster antenna circuit (744) disposed behind the shielding layer, and also has a coupling frame (metal layer 750 with a slit) disposed behind the booster antenna circuit.

The FIG. 7B construction has a coupling frame (metal layer 750 with a slit) disposed behind the shielding layer, and also has a booster antenna circuit (744) disposed behind the coupling frame.

FIGS. 5A/B, 6A/B/C and 7A/B include what may be called an “Amplifying Element” located in the stackup (construction) of the card body, to offset the attenuating effects of the front (continuous) metal layer (ML; 530, 630, 730). In FIGS. 5A/B, the amplifying element is realized as a coupling frame antenna (CFA) 507. In FIGS. 6A/B/C, the amplifying element is realized as a coupling frame (CF) 650. In FIGS. 7A/B, the amplifying element is realized as a booster antenna circuit (BAC) 744.

FIG. 8A shows a metal card body with an opening to accept the implanting of an inductive coupling chip module and the corresponding dimensions thereof with a rear synthetic layer (laser engravable overlay) capturing the security elements (not shown), and ready for lamination to the metal layer.

FIG. 8B shows a metal card body with the opening to accept the implanting of the inductive coupling chip module and the synthetic layer laminated to the metal layer. The opening may be oversized to allow a compound to be dispensed into the void. The compound may be a non-conductive medium or a ferromagnetic medium to concentrate magnetic flux lines around the inductive coupling chip module.

FIG. 8C shows a metal card body with the opening filled with a compound and cured to a solid state. The compound may be partially or fully dispensed into the area.

FIG. 8D shows a metal card body with the solid compound structure machined to have a recess area matching the shape and dimensions of the inductive coupling chip module. As an alternative method to mechanically milling the compound structure, the compound may be formed using an ultrasonic tool or hot stamp tool.

The compound may be a UV curing resin such as Colorit®. Reference is made to https://www.heimerle-meule.com/products/coloritr/working-with-colorit/FIG. 8E is a side view of a transaction card embodying the invention showing a metal card body with an inductive coupling chip module implanted in the machined recessed area having interior walls composed of the compound structure. Pre-implanting, the compound structure has been milled or formed into shape.

The Module Cavity

A mechanically milled oversized module cavity in a metal transaction card (metal core or metal face) may be filled with a compound, allowed to cure to a harden state, and thereafter a pocket is milled in the solid compound to accept the outline and form of the module tape and the mold mass of a transponder chip module (aka an inductive coupling chip module (ICM)). The compound may be an epoxy resin such as Bisphenol, Novolac, Aliphatic, and Glycidylamine.

The fill process may be a dispensing, encapsulation, injection molding, transfer molding or potting process.

In creating the module cavity in a metal transaction card having a nominal thickness of 760 μm, there are two process steps in the CNC milling to form a stepped cavity. The first process step is to mill the P1 cavity which has a depth of 250 μm (to match the thickness of the glass epoxy tape 190 μm (module tape (MT)) and the hot-melt tape 60 μm (adhesive layer)) and has lateral dimensions which are slightly larger (typically 80 to 100 μm on all four sides) than the module tape having 6 or 8 contact pads. The second process step is to mill the P2 cavity to a depth of at least 580 μm which represents the overall thickness of the transponder chip module from the front contact pads to the rear edge of the mold mass. The shape of the cavity to accept the mold mass of the transponder chip module may be square having dimensions of 7 mm in the x and y axis.

Whether the transaction card is a laminated metal core (plastic-metal-plastic) or a metal face (metal-plastic) smartcard with dual interface capability, there is always a plastic layer on the rear of the metal card body to house the magnetic stripe and the security elements (signature panel and hologram) which are hot stamped to the plastic surface. The plastic layer is usually an overlay layer having a thickness of 50 μm.

In mechanically milling the stepped cavity from the front face to the rear face of the transaction card, the milling tool during CNC milling of the stepped cavity invariably reaches the rear overlay layer which is extremely thin and can be easily distorted or wrinkled if pressure is applied to the area of the module opening in the metal card body for which the rear overlay material covers and protects.

Another process problem associated with the implanting of a transponder chip module is the adhesion of the glass epoxy tape with gold plated copper tracks on its face down side which form the module antenna, to the metal layer which acts as the coupling frame to facilitate contactless communication, using an adhesive tape applied to the module tape. The adhesion is hampered by the interface of the glass epoxy with another adhesive layer used to attach the plastic (printed layer) with the metal. The interface with poor adhesion results in a chip module that can easily pop out from the module pocket of the card body.

After CNC milling the P1 and P2 cavities, a compound may used to fill the stepped cavity area, which can be regarded as a potting or encapsulation process. In a further step, a module pocket is milled out from the potting compound.

The advantage of this process is two-fold. Firstly, the glass epoxy tape can be easily attached with the adhesive tape to the metal layer or a synthetic layer in the card body. Secondly the rear area of the module cavity is protected with the potting compound, thus preventing distortion of the overlay material.

The milling of an oversized pocket, filling the pocket with a non-conductive compound, and then mechanically forming the compound to have well-defined dimensions to accept the form and shape of an electronic component can simplify the manufacturing of metal transaction cards with a biometric sensor or display. The mechanical forming may be milling, stamping, or any forming process using heat, cooling, pressure or vacuum. The compound may be formed in a solid, liquid or molten state. For example, the compound may be dispensed into the pocket and with a forming tool pressed into shape to accept the contours of an electronic component. The compound may also be formed using an ultrasonic tool.

To further assist in the adhesion of the inductive coupling chip module with a backing adhesive layer or tape to a metal surface or a formed compound surface, the underlying card body substrate can be pre-heated using hot blowers, heating elements or infra light.

The same potting procedure can be implemented to reinforce a slit (discontinuity) in a metal card body. The prior art suggests using a metal backing insert with a slit or a plastic backing insert, to stabilize a discontinuity in a metal card body.

Recess/Filling

A recess around the rear area of a discontinuity (slit) in a metal card body may be chemically etched at each card body site in a metal inlay format, such as 2×8 or 5×5 array of sites. At each recess area in the array of card body sites, a compound may be used to fill each recess, preferably with a compound which can withstand high temperatures such as those used in a paint bake process (400° F.).

The chemical etching can create the recess. Additionally, trenches or gratings may be produced in the metal to support the adhesion of the compound. The compound may contain nanofibers to produce a composite structure.

During singulation of a card body from a metal inlay, there is a risk of smearing of the metal around the area of the slit at the perimeter edge of the card body. This smearing is caused by ageing or dulling of the CNC milling tool over time. This smearing of the slit also occurs during milling of the module pocket where the slit terminates in the module opening. The prior art suggests creating slit termination holes (STH) at each card body site in the metal inlay where the slit reaches the module opening, but it is silent on the effects of smearing of the slit at the perimeter edge of the card body. This smearing of the metal results in electrical shorting of the slit, impairing the contactless functionality of the transaction card.

Therefore, the slits in the metal layer or metal layers of the transaction card may terminate at the module opening with a shape in the form of a semi-circle “(” or delta “<”. In addition, the slit commencing at the perimeter edge of the card body may also be in the form of a semi-circle “(” or delta “<”, to avoid metal smearing of the slit when the milling tool ages with time.

Disguising the presence of a discontinuity in a metal layer or a metal card body have been discussed above, in which an epoxy resin (one or two component) is used to fill the slit or slits, and thereafter in a paint bake process, the entire metal area is covered with a color and protected by a clear lacquer which gives the metal a gloss or satin finish. In another embodiment of the invention to protect the surface finish of the paint bake layer on the metal surface from scratches during the lamination of the rear plastic layers with security elements and graphic features to the metal layer, a hard coat layer is laminated to the exposed metal surface. This hard coat layer may be matt or gloss depending on the surface finish of the lamination plates. To engrave a deboss logo, a picosecond laser may be used to ablate the hard coat, lacquer, paint and metal layers.

In producing a metal transaction card with a metal foil hologram, it is an embodiment of the invention to first laminate a hard coat layer to the metal surface, and thereafter to hot stamp the metal foil hologram to the hard coat layer. The prior art suggests hot stamping the metal foil hologram to a synthetic layer (overlay) and not to a hard coat layer laminated to the metal layer.

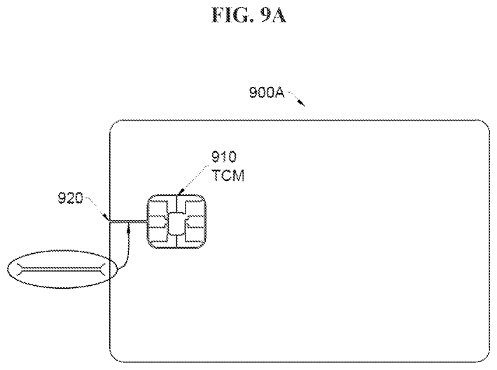

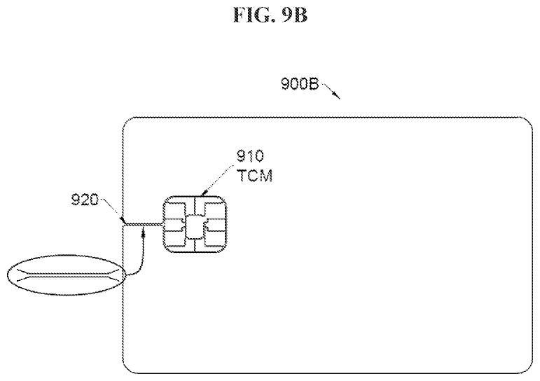

FIG. 9A shows a slit 920 commencing at a perimeter edge of the metal card body 900A and terminating at the inductive coupling chip module 910, with the slit exhibiting a semi-circle opening shape at each end of the slit.

FIG. 9B shows a slit 920 commencing at a perimeter edge of the metal card body 900B and terminating at the inductive coupling chip module 910, with the slit exhibiting a delta (triangular) opening shape at each end of the slit.

The slit termination hole (STH) at the module opening may be disclosed in some prior art patents, but the technique disclosed herein goes one step further and creates an STH at the perimeter of the card body, which helps a lot.

CNC Milling

Typically, cards may be manufactured (laid up and laminated) in sheet form, each sheet having a plurality of cards, such as in a 5×5 array, and CNC (computer numerical control) machining may be used to singulate (separate) the finished cards from the sheet. Resulting burrs, particularly in the metal layers, may cause defects, such as electrical shorting of the slit. Hence, CNC machining of metal core, metal face or solid metal smartcards may be performed using cryogenic milling, such as in an environment of frozen carbon dioxide or liquid nitrogen.

Some Additional Comments

Some of the card embodiments disclosed herein may have two metal layers, separated by a dielectric coating or an insulating layer, rather than a single metal layer. The two metal layers may comprise different materials and may have different thicknesses than one another. For example, one of the metal layer may be stainless steel while the other metal layer may be titanium. In this manner, the “drop acoustics” of the metal card body may be improved, in that the card, when dropped or tapped (edgewise) on a hard surface, sounds like a solid metal card (making a ringing or tinkling sound), rather than like a plastic card (making a “thud”).

Generally, in order for the smartcard to be “RFID-enabled” (able to interact “contactlessly”), each of the one or more metal layers should have a slit, or micro-slit. When there are two (or more) metal layers with slits in the stack-up, the slits in the metal layers should be offset from one another.

Some Generic Characteristics

The smartcards described herein may have the following generic characteristics:
The card body may have dimensions similar to those of a credit card. ID-1 of the ISO/IEC 7810 standard defines cards as generally rectangular, measuring nominally 85.60 by 53.98 millimeters (3.37 in×2.13 in).
A chip module (RFID, contact type, or dual interface) may be implanted in a recess (cavity, opening) in the card body. The recess may be a stepped recess having a first (upper, P1 portion) having a cavity depth of 250 μm, and a second (lower, P2 portion) having a cavity depth of (maximum) 600 μm.
A contact-only or dual interface chip module will have contact pads exposed at a front surface of the card body.
ISO 7816 specifies minimum and maximum thickness dimensions of a card body:
   Min 0.68 mm (680 μm) to Max 0.84 mm (840 μm) or Min 0.027 inch to Max 0.033 inch

Generally, any dimensions set forth herein are approximate, and materials set forth herein are intended to be exemplary. Conventional abbreviations such as “cm” for centimeter”, “mm” for millimeter, “μm” for micron, and “nm” for nanometer may be used.

The concept of modifying a metal element of an RFID-enabled device such as a smartcard to have a slit (S) to function as a coupling frame (CF) may be applied to other products which may have an antenna module (AM) or transponder chip module (TCM) integrated therewith, such as watches, wearable devices, and the like.

Some of the features of some of the embodiments of RFID-enabled smartcards may be applicable to other RFID-enabled devices, such as smartcards having a different form factor (e.g., size), ID-000 (“mini-SIM” format of subscriber identity modules), keyfobs, payment objects, and non-secure NFC/RFID devices in any form factor

The RFID-enabled cards (and other devices) disclosed herein may be passive devices, not having a battery and harvesting power from an external contactless reader (ISO 14443). However, some of the teachings presented herein may find applicability with cards having self-contained power sources, such as small batteries (lithium-ion batteries with high areal capacity electrodes) or supercapacitors.

The transponder chip modules (TCM) disclosed herein may be contactless only, or dual-interface (contact and contactless) modules.

In their various embodiments, the invention(s) described herein may relate to payment smartcards (metal, plastic or a combination thereof), electronic credentials, identity cards, loyalty cards, access control cards, and the like.

While the invention(s) may have been described with respect to a limited number of embodiments, these should not be construed as limitations on the scope of the invention(s), but rather as examples of some of the embodiments of the invention(s). Those skilled in the art may envision other possible variations, modifications, and implementations that are also within the scope of the invention(s), and claims, based on the disclosure(s) set forth herein.

What is claimed is:

1. Smartcard having a card body comprising:
a front metal layer (730) having a first module opening (MO; 712);
a shielding layer (742) disposed behind the front metal layer;
a booster antenna circuit (BAC; 744) disposed behind the shielding layer; and
a metal interlayer or layers (750) each having a second module opening (714) and a slit (720);
wherein the front metal layer does not have a slit extending from a peripheral edge of the front metal layer to the first module opening.

2. The smartcard of claim 1, further comprising:
a dielectric spacer (738) disposed between the front metal layer and the shielding layer.

3. The smartcard of claim 1, wherein:
a portion of the front metal layer protrudes downward into an opening in the shielding layer.

4. The smartcard of claim 1, wherein:
the metal interlayer or layers is disposed behind the booster antenna circuit.

5. The smartcard of claim 1, wherein:
the metal interlayer or layers is disposed between the front metal layer and the booster antenna circuit.

6. The smartcard of claim 1, further comprising:
a protective hard coat layer (724) disposed on the front metal layer.

7. The smartcard of claim 1, further comprising:
a print layer (726) disposed between the hard coat layer and the front metal layer.

8. The smartcard of claim 1, further comprising:
a transparent, translucent or white synthetic layer (760) disposed behind the metal interlayer or layers.

9. The smartcard of claim 8, further comprising:
at least one of primer (762) and ink (764) disposed on the synthetic layer.

10. The smartcard of claim 8, further comprising:
a laser engravable overlay layer (770) disposed behind the synthetic layer.

11. The smartcard of claim 1, further comprising:
a dual-interface module (710) inserted into the module openings of the card body.

12. Transaction card having at least contactless capability comprising:
a dual interface transponder chip module (TCM; 500A,B) having a dual interface RFID chip and a module antenna;
a metal layer (530) having a module opening (506) and no slit;
a radio frequency shielding layer (540) comprising ferrite material disposed behind the metal layer; and
a coupling frame antenna (CFA) on a support substrate (502) disposed behind the shielding layer and comprising a single turn or track having a slit or gap extending from an outer edge of the coupling frame antenna to an inner position thereof, wherein the slit or gap of the coupling frame antenna is disposed to overlap at least a portion of the module antenna.

13. The transaction card of claim 12, further comprising:
a dielectric spacer disposed between the front metal layer and the shielding layer.

14. The transaction card of claim 12, wherein:
a portion of the metal layer protrudes downward into an opening in the shielding layer.

15. The transaction card of claim 12, further comprising:
at least one plastic layer (560) disposed behind the support substrate.

16. The transaction card of claim 15, further comprising:
a magnetic stripe and security elements disposed on the plastic layer.

17. The transaction card of claim 12, further comprising:
a second coupling frame antenna having a slit or gap extending from an outer edge of the coupling frame antenna to an inner position thereof, and stacked with the coupling frame antenna; and
a dielectric layer disposed between the coupling frame antenna and the second coupling frame antenna.

18. The transaction card of claim 12, wherein:
the slit is disposed to overlap at least a portion of the module antenna.

19. The transaction card of claim 12, wherein:
the coupling frame antenna is configured to inductively couple to the dual interface transponder chip module.

20. The transaction card of claim 12, wherein:
the coupling frame antenna is physically connected in series or parallel with the module antenna of the dual interface transponder chip module.

21. The transaction card of claim 12, wherein:
the coupling frame antenna is physically connected to pads linked to antenna connections La and Lb on the dual interface chip.

22. An RFID-enabled metal transaction card comprising:
a front face metal layer (ML; 530, 630, 730) with a module opening for a chip module, and without a slit extending from a peripheral edge of the front metal layer to the module opening;
wherein the card is capable of operating in contactless mode from the rear side of the card body.

23. The transaction card of claim 22, further comprising:
a shielding layer disposed behind the front metal layer.

24. The transaction card of claim 23, further comprising:
a dielectric spacer disposed between the metal layer and the shielding layer.

25. The transaction card of claim 23, wherein:
a portion of the metal layer protrudes downward into an opening in the shielding layer.

26. The transaction card of claim 22, further comprising:
a rear synthetic layer (560, 660, 760).

27. The transaction card of claim 22, wherein:
the card has an activation distance of at least 4 cm.

28. The transaction card of claim 22, wherein:
the card has drop acoustics which sound like metal.

29. The transaction card of claim 22, further comprising:
a shielding layer (540, 640, 742) disposed behind the front face metal layer; and
an amplifying element (CFA, CF, BAC) disposed behind the shielding layer.

30. Smartcard having a card body comprising:
a front metal layer (630) having a module opening (MO; 612);
a shielding layer (640) disposed behind the front metal layer; and
a coupling frame (CF; 650) disposed behind the shielding layer;
wherein the front metal layer does not have a slit extending from a peripheral edge of the front metal layer to the module opening.

31. The smartcard of claim 30, further comprising:
a dielectric spacer (638) disposed between the front metal layer and the shielding layer.

32. The smartcard of claim 30, wherein:
a portion of the metal layer protrudes downward into an opening in the shielding layer.

33. The smartcard of claim 30, further comprising:
a protective hard coat layer 624) disposed on the front metal layer.

34. The smartcard of claim 33, further comprising:
a print layer (626) disposed between the hard coat layer and the front metal layer.

35. The smartcard of claim 30, further comprising:
a metal interlayer or layers (650) disposed behind the shielding layer.

36. The smartcard of claim 35, further comprising:
a transparent, translucent or white synthetic layer (660) disposed behind the metal interlayer or layers.

37. The smartcard of claim 36, further comprising:
at least one of primer (662) and ink (664) disposed on the synthetic layer; and
a laser engravable overlay layer (670) disposed behind the synthetic layer.

38. The smartcard of claim 30, further comprising:
a dual-interface module (610) inserted into the module openings of the card body.

39. A process for manufacturing an RFID-enabled metal transaction card comprising the steps of:
CNC milling an opening in a card body of the transaction card;
filling the opening partially or entirely with a compound;
mechanically forming the compound as a structure having the shape and dimensions of an electronic component; and
inserting the electronic component into the formed compound structure.

40. The process of claim 39, wherein the step of forming the compound comprises:
applying an ultrasonic tool or hot stamp to the compound under pressure and temperature to compress and shape the compound to accept the insertion of the electronic component.

41. The process of claim 39, wherein the step of inserting the electronic component comprises:
placing the electronic component with an adhesive backing layer into the formed compound using heat and pressure.

42. The process of claim 41, wherein:
the step of inserting the electronic component is performed after the step of forming the compound.

43. The process of claim 39, further comprising the step of:
creating one or more securing features in the card body for securing the formed compound material to the card body.

44. The process of claim 43, wherein:
the securing features comprise pockets in the card body.

45. The process of claim 39, wherein:
the CNC milled opening extends partially or entirely through the card body.

46. The process of claim 39, wherein:
the compound material is an epoxy resin having a forming temperature range which can withstand high paint bake temperatures of approximately 300-400° F.
